(19) United States
(12) Patent Application Publication
(10) Pub. No.: US 2011/0251007 A1
(43) Pub. Date: Oct. 13, 2011

(54) Dual gear train driving structure at input side of basin-type gear

(76) Inventor: Tai-Her Yang, Dzan-Hwa (TW)

(21) Appl. No.: 12/662,258

(22) Filed: Apr. 7, 2010

(51) Int. Cl. F16H 3/72; F16H 37/08

(52) U.S. Cl. 475/1

(57) ABSTRACT

For the dual gear train driving structure at input side of basin-type gear of the present invention, the differential gear set input rocker arm driven by the basin-type bevel gear in the differential gear set assembly is made to be driven by two sets of transmissions, in which the first transmission transmits the rotary kinetic energy between the differential gear set input rocker arm and the engine, the second transmission transmits the rotary kinetic energy between the differential gear set input rocker arm and the second driving unit, and one or both of the transmissions drives the differential gear set input rocker arm.

### BACKGROUND OF THE INVENTION

(a) Field of the Invention

For the dual gear train driving structure at input side of basin-type gear of the present invention, the differential gear set input rocker arm driven by the basin-type bevel gear in the differential gear set assembly is made to be driven by two sets of transmissions, in which the first transmission transmits the rotary kinetic energy between the differential gear set input rocker arm and the engine, the second transmission transmits the rotary kinetic energy between the differential gear set input rocker arm and the second driving unit, and one or both of the transmissions drives the differential gear set input rocker arm.

(b) Description of the Prior Art

Traditionally, for the hybrid drive system, in which the basin-type bevel gear of the differential gear set assembly drives the differential gear set, the drive bevel gear at the input side of the differential gear set usually couples with the basin-type bevel gear to form the first transmission, to transmit the power from the engine, and the bevel gear driven by the second driving unit, such as the electric machinery, couples with the same basin-type bevel gear to transmit the kinetic energy between itself and the electric machinery, and the shortcomings are that the basin-type bevel gear driven by the kinetic energy of the electric machinery of the second driving unit and the engine is transmitted by the input bevel gear, thus the speed ratio is limited to be the same with that of the input side of the engine, and the bevel gear must be the same with another coupled input bevel gear driven by the rotary kinetic energy of the engine.

### SUMMARY OF THE INVENTION

Traditionally, for the hybrid drive system, in which the basin-type bevel gear of the differential gear set assembly drives the differential gear set, the drive bevel gear at the input side of the differential gear set usually couples with the basin-type bevel gear to form the first transmission, to transmit the power from the engine, and the bevel gear driven by the second driving unit, such as the electric machinery, couples with the same basin-type bevel gear to transmit the kinetic energy between itself and the electric machinery, and the shortcomings are that the basin-type bevel gear driven by the kinetic energy of the electric machinery of the second driving unit and the engine is transmitted by the input bevel gear, thus the speed ratio is limited to be the same with that of the input side of the engine, and the bevel gear must be the same with another coupled input bevel gear driven by the rotary kinetic energy of the engine;

For the dual gear train driving structure at input side of basin-type gear of the present invention, the differential gear set input rocker arm driven by the basin-type bevel gear for the function of transmission, in the differential gear set assembly, is made to be driven by two sets of transmissions, in which the first transmission transmits the rotary kinetic energy between the differential gear set input rocker arm and the engine, the second transmission transmits the rotary kinetic energy between the differential gear set input rocker arm and the second driving unit, and one or both of the transmissions drives the differential gear set input rocker arm;

For the dual gear train driving structure at input side of basin-type gear, the second driving unit is used for the operations of the motor and/or the power generation function through powered electric machinery, or the fluid force rotary driving unit driven by hydraulic pressure or atmospheric pressure, or the rotary driving unit driven by flywheel or spring is used to be the second driving unit.

### BRIEF DESCRIPTION OF THE DRAWINGS

FIG. 1 is a structural schematic diagram showing the conventional basin-type bevel gear, which is together driven by the bevel gear driven by the engine and the bevel gear driven by the second driving unit.

FIG. 2 is a structural schematic diagram showing the main components of the dual gear train driving structure at input side of basin-type gear, according to the present invention.

FIG. 3 is a structural schematic diagram showing that the rotary part of electric machinery constituting single set of the second driving unit (201) drives the transmission gear of the second transmission (506) through second transmission input gear (505), and along with the basin-type bevel gear of the first transmission (504) individually or together drive the umbrella-type planetary gear power transmission rocker arm (804), according to the present invention.

FIG. 4 is a structural schematic diagram showing the embodiment that the clutch unit (CL201) is installed between the output terminal of the rotary part of the electric machinery constituting single set of the second driving unit (201) and the second transmission input gear (505) in FIG. 3.

FIG. 5 is a structural schematic diagram showing the embodiment that a speed variable transmission (T201) is installed between the output terminal of the rotary part of the electric machinery constituting single set of the second driving unit (201) and the second transmission input gear (505) in FIG. 3.

FIG. 6 is a structural schematic diagram showing the embodiment that the output terminal of the rotary part of the electric machinery constituting single set of the second driving unit (201) in FIG. 3 is through the clutch unit (CL201) and then through the speed variable transmission (T201) connected to the second transmission input gear (505).

FIG. 7 is a structural schematic diagram showing the embodiment that two sets of the output terminals of the rotary part of the electric machinery constituting the second driving unit (201) in FIG. 3 is through the speed variable transmission (T201) and then through the controllable clutch unit (CL201) connected to the second transmission input gear (505) in FIG. 3.

FIG. 8 is a structural schematic diagram showing the embodiment that two electric machineries constituting the second driving units (201) and (202) are further installed to the embodiment of FIG. 3 for commonly driving the input terminal of the second transmission (302), according to the present invention.

FIG. 9 is a structural schematic diagram showing the embodiment that two electric machineries constituting the second driving units (201) and (202) are further installed to the embodiment of FIG. 4, and the two controllable clutch units (CL201) and (CL202) are individually installed between each of the output terminals of the rotary parts of the two electric machineries and the second transmission input gear (505).

FIG. 10 is a structural schematic diagram showing the embodiment that two electric machineries constituting the second driving units (201) and (202) are further installed to the embodiment of FIG. 5, and the two speed variable transmissions (T201) and (T202) are individually installed between each of the output terminals of the rotary parts of the two electric machineries and the second transmission input gear (505).

FIG. 11 is a structural schematic diagram showing the embodiment that two electric machineries constituting the second driving units (201) and (202) are further installed to the embodiment of FIG. 6, and the output terminals of the rotary parts of the two electric machineries are individually through the controllable clutch units (CL201) and (CL202) and then through the speed variable transmissions (T201) and (T202) connected to the second transmission input gear (505).

FIG. 12 is a structural schematic diagram showing the embodiment that two electric machineries constituting the second driving units (201) and (202) are further installed in the embodiment of FIG. 7, and the output terminals of the rotary parts of the two electric machineries are individually through the speed variable transmissions (T201) and (T202) and then through the controllable clutch units (CL201) and (CL202) connected to the second transmission input gear (505).

FIG. 13 is a structural schematic diagram showing the embodiment of integrated dual basin-type bevel gear set with same outer diameter (400).

FIG. 14 is a structural schematic diagram showing the embodiment of integrated dual basin-type bevel gear set with different outer diameters (410), according to the present invention.

FIG. 15 is a structural schematic diagram showing the embodiment of integrated transmission gear and bevel gear set (420), according to the present invention.

FIG. 16 is a structural schematic diagram showing the embodiment of integrated transmission sprocket and basin-type bevel gear set (430), according to the present invention.

FIG. 17 is a structural schematic diagram showing the embodiment of integrated transmission pulley and basin-type bevel gear set (440), according to the present invention.

FIG. 18 is a structural schematic diagram showing the embodiment of integrated transmission CVT wheel and basin-type bevel gear set (450), according to the present invention.

FIG. 19 is a structural schematic diagram showing the embodiment of combined dual basin-type bevel gear set with same outer diameter (500), according to the present invention.

FIG. 20 is a structural schematic diagram showing the embodiment of combined dual basin-type bevel gear set with different outer diameter (510), according to the present invention.

FIG. 21 is a structural schematic diagram showing the embodiment of combined transmission gear and basin-type bevel gear set (520), according to the present invention.

FIG. 22 is a structural schematic diagram showing the embodiment of combined transmission sprocket and basin-type bevel gear set (530), according to the present invention.

FIG. 23 is a structural schematic diagram showing the embodiment of combined transmission pulley and basin-type bevel gear set (540), according to the present invention.

FIG. 24 is a structural schematic diagram showing the embodiment of combined transmission CVT wheel and basin-type bevel gear set (550), according to the present invention.

FIG. 25 is a structural schematic diagram showing the embodiment of dual basin-type bevel gear set (600) with same outer diameter and with the clutch unit (CL500), according to the present invention.

FIG. 26 is a structural schematic diagram showing the embodiment of dual basin-type bevel gear set with different outer diameters (610) and with the clutch unit (CL500), according to the present invention.

FIG. 27 is a structural schematic diagram showing the embodiment of the transmission gear and basin-type bevel gear set (620) with the clutch unit (CL500), according to the present invention.

FIG. 28 is a structural schematic diagram showing the embodiment of the transmission sprocket and basin-type bevel gear set (630) with the clutch unit (CL500), according to the present invention.

FIG. 29 is a structural schematic diagram showing the embodiment of the transmission pulley and basin-type bevel gear set (640) with the clutch unit (CL500), according to the present invention.

FIG. 30 is a structural schematic diagram showing the embodiment of the transmission CVT wheel and basin-type bevel gear set (650) with the clutch unit (CL500), according to the present invention.

FIG. 31 is a structural schematic diagram showing the embodiment that the output terminal of the rotary part of electric machinery constituting the single set of the second driving unit (201) couples with the basin-type bevel gear of the first transmission (504) through the second transmission (302) and the controllable clutch unit (CL500), and then connects with the umbrella-type planetary gear power transmission rocker arm (804), according to the present invention.

FIG. 32 is a structural schematic diagram showing the embodiment that the speed variable transmission (T201) is installed between the output terminal of the rotary part in the second driving unit (201) and the input terminal of the second transmission (302) in FIG. 31, and the second transmission (302) and the controllable clutch unit (CL500) couple with the basin-type bevel gear of the first transmission (504), and then connect to the umbrella-type planetary gear power transmission rocker arm (804), according to the present invention.

FIG. 33 is a structural schematic diagram showing the embodiment that two electric machineries are further installed to the embodiment of FIG. 31 to constitute the second driving units (201) and (202) to together drive the input terminal of the second transmission (302), according to the present invention.

FIG. 34 is a structural schematic diagram showing the embodiment that two electric machineries are further installed to constitute the second driving units (201) and (202), and the speed variable transmission (T201) and the speed variable transmission (T202) are installed, according to the present invention.

FIG. 35 is a structural schematic diagram showing the embodiment that the second transmission (302) driven by the output terminal of the rotary part of the electric machinery constituting the single set of the second driving unit (201) combines with the umbrella-type planetary gear power transmission rocker arm (804) at left side of the differential gear set (800) through the controllable clutch unit (CL500), while the umbrella-type planetary gear power transmission rocker arm (804) at right side rightward extends and combines with the basin-type bevel gear of the first transmission (504), and is subject to be driven by the first driving unit (101) through the first transmission input bevel gear (503), according to the present invention.

FIG. 36 is a structural schematic diagram showing the embodiment that the speed variable transmission (T201) is installed between the output terminal of the rotary part of electric machinery in the second driving unit (201) and the input terminal of the second transmission (302) in the embodiment of FIG. 35, according to the present invention.

FIG. 37 is a structural schematic diagram showing the embodiment that the rotary power source driven by two electric machineries constitutes the second driving units (201) and (202) in the embodiment of FIG. 35, according to the present invention.

FIG. 38 is a structural schematic diagram showing the embodiment that the rotary power source driven by two electric machineries constitutes the second driving units (201) and (202) in the embodiment of FIG. 36, according to the present invention.

FIG. 39 is a structural schematic diagram showing the embodiment that the controllable clutch unit (CL5011) is installed between the umbrella-type planetary gear power transmission rocker arm (804) and the driving wheel group of the first transmission (301), and the controllable clutch unit (CL5012) is installed between the umbrella-type planetary gear power transmission rocker arm (804) and the driving wheel group of the second transmission (302), according to the present invention.

FIG. 40 is a structural schematic diagram showing the embodiment that the speed variable transmission (T201) is additionally installed between the output terminal of the second driving unit (201) and the input terminal of the second transmission (302) in FIG. 39, according to the present invention.

FIG. 41 is a structural schematic diagram showing the embodiment that the rotary power source driven by two electric machineries constitutes the second driving units (201) and (202) in FIG. 39, according to the present invention.

FIG. 42 is a structural schematic diagram showing the embodiment that the rotary power source driven by two electric machineries constitutes the second driving units (201) and (202) in FIG. 40, according to the present invention.

FIG. 43 is a structural schematic diagram showing the embodiment that the second driving unit (201) constituted by the single electric machinery drives the input terminal of the second transmission (302), and the umbrella-type planetary gear power transmission rocker arm (804) is installed at two sides of the differential gear set (800), in which the controllable clutch unit (CL5011) is installed between one side of the umbrella-type planetary gear power transmission rocker arm (804) and the basin-type bevel gear of the first transmission (504), while the controllable clutch unit (CL5012) is installed between the other side of the umbrella-type planetary gear power transmission rocker arm (804) and the second transmission (302), according to the present invention.

FIG. 44 is a structural schematic diagram showing the embodiment that single electric machinery constitutes the second driving unit (201), and the speed variable transmission (T201) is installed between the output terminal of the second driving unit (201) and the input terminal of the second transmission (302), according to the present invention.

FIG. 45 is a structural schematic diagram showing the embodiment that two electric machineries are further installed for constituting the second driving units (201) and (202) in the embodiment of FIG. 43 to together drive the input terminal of the second transmission (302), according to the present invention.

FIG. 46 is a structural schematic diagram showing the embodiment that the embodiment of FIG. 44 are further installed with two electric machineries for constituting the second driving units (201) and (202), and the speed variable transmission (T201) and the speed variable transmission (T202) are installed, according to the present invention.

FIG. 47 is a structural schematic diagram showing the embodiment that single electric machinery constitutes the second driving unit (201) for driving the second transmission input bevel gear (507) at the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, according to the present invention.

FIG. 48 is a structural schematic diagram showing the embodiment that single electric machinery constitutes the second driving unit (201), and the speed variable transmission (T201) is installed between the output terminal of the second driving unit (201) and the second transmission input bevel gear (507) at the input terminal of the second transmission (302) in FIG. 47.

FIG. 49 is a structural schematic diagram showing the embodiment that the single electric machinery constitutes the second driving unit (201) for driving the second transmission input bevel gear (507) at the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, the two sets are in separation, and the controllable clutch unit (CL500) is installed between the basin-type bevel gear of the second transmission (5042) and the umbrella-type planetary gear power transmission rocker arm (804), according to the present invention.

FIG. 50 is a structural schematic diagram showing the embodiment that single electric machinery constitutes the second driving unit (201), and the speed variable transmission (T201) is installed between the output terminal of the second driving unit (201) and the second transmission input bevel gear (507) at the input terminal of the second transmission (302) in FIG. 49.

FIG. 51 is a structural schematic diagram showing the embodiment that the single electric machinery constitutes the second driving unit (201) for driving the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, the two sets are in separation, the controllable clutch unit (CL5011) is installed between the basin-type bevel gear of the first transmission (504) and the umbrella-type planetary gear power transmission rocker arm (804), and the controllable clutch unit (CL5012) is installed between the basin-type bevel gear of the second transmission (5042) and the umbrella-type planetary gear power transmission rocker arm (804), according to the present invention.

FIG. 52 is a structural schematic diagram showing the embodiment that the single electric machinery constitutes the second driving unit (201), and the speed variable transmission (T201) is installed between the output terminal of the second driving unit (201) and the second transmission input bevel gear (507) at the input terminal of the second transmission (302) in the embodiment of FIG. 51.

### DESCRIPTION OF MAIN COMPONENT SYMBOLS

(CL101), (CL201), (CL202), (CL500), (CL5011), (CL5012): Controllable clutch unit

(101): First driving unit

(201), (202): Second driving unit

(T201), (T202): Speed variable transmission

(300): Differential gear set assembly

(301): First transmission

(302): Second transmission

(311), (312): Differential output shaft

(400): Integrated dual basin-type bevel gear set with same outer diameter

(410): Integrated dual basin-type bevel gear set with different outer diameter

(420): Integrated transmission gear and basin-type bevel gear set

(430): Integrated transmission sprocket and basin-type bevel gear set

(440): Integrated transmission pulley and basin-type bevel gear set

(450): Integrated transmission CVT wheel and basin-type bevel gear set

(500): Combined dual basin-type bevel gear set with same outer diameter

(501): Separate basin-type bevel gear

(502): Combined transmission gear

(503): First transmission input bevel gear

(504): Basin-type bevel gear of the first transmission

(505): Second transmission input gear

(506): Transmission gear of the second transmission

(507): Second transmission input bevel gear

(510): Combined dual basin-type bevel gear set with different outer diameter

(520): Combined transmission gear and basin-type bevel gear set

(530): Combined transmission sprocket and basin-type bevel gear set

(540): Combined transmission pulley and basin-type bevel gear set

(550): Combined transmission CVT wheel and basin-type bevel gear set

(600): Dual basin-type bevel gear set with same outer diameter and clutch unit

(610): Dual basin-type bevel gear set with different outer diameter and clutch unit

(620): Transmission gear and basin-type bevel gear set with clutch unit

(630): Transmission sprocket and basin-type bevel gear set with clutch unit

(640): Transmission pulley and basin-type bevel gear set with clutch unit

(650): Transmission CVT wheel and basin-type bevel gear set with clutch unit

(800): Differential gear set

(801): Left umbrella-type differential output wheel

(802): Right umbrella-type differential output wheel

(803): Umbrella-type planetary gear set

(804): Umbrella-type planetary gear power transmission rocker arm

(5041), (5042): Basin-type bevel gear of the second transmission

(5061): Transmission sprocket of the second transmission

(5062): Transmission pulley of the second transmission

(5063): Transmission CVT wheel of the second transmission

### DETAILED DESCRIPTION OF THE PREFERRED EMBODIMENTS

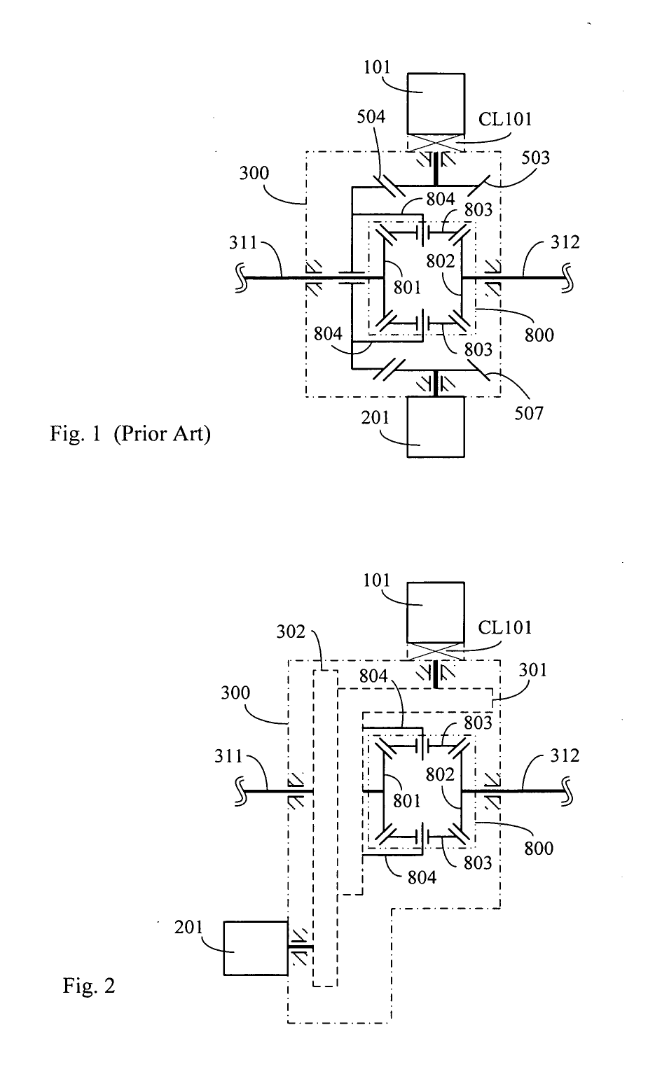

Traditionally, for the hybrid drive system, in which the basin-type bevel gear of the differential gear set assembly drives the differential gear set, as shown in FIG. 1, the first transmission input bevel gear (503) at the input side of differential gear set assembly (300) usually couples with the basin-type bevel gear of the first transmission (504) to form the first transmission (301), so as to directly or through the controllable clutch unit (CL101) transmit the power from the first driving unit (101), such as engine, and by means of the rotary kinetic energy of the second driving unit (201), such as electric machinery, to drive the second transmission input bevel gear (507) served as the second transmission (302), thereby to common couple to the same basin-type bevel gear of the first transmission (504) with the first transmission input bevel gear (503) to transmit and rotate the kinetic energy, including that, the engine power and/or the electric machinery to implement the function of motor to drive the basin-type bevel gear of the first transmission (504), and the basin-type bevel gear of the first transmission (504) via the second transmission input bevel gear (507) integrated at the rotary part of the electric machinery to drive the electric machinery to operate the power generation function; and the shortcomings are that the second transmission input bevel gear (507) driven by the electric machinery of the second driving unit (201) and the first transmission input bevel gear (503) driven by the engine power of the first driving unit (101) drive the basin-type bevel gear of the first transmission (504) together, thus the speed ratio of the driving side of the electric machinery is limited to be the same with that of the input side of the engine, and the second transmission input bevel gear (507) must be the same with the coupled first transmission input bevel gear (503) driven by the engine rotary kinetic energy;

For the dual gear train driving structure at input side of basin-type gear of the present invention, the umbrella-type planetary gear power transmission rocker arm (804) for driving the differential gear set (800) in the differential gear set assembly (300) is made to be driven by two sets of transmissions, in which the first transmission (301) transmits the rotary kinetic energy between the umbrella-type planetary gear power transmission rocker arm (804) of the differential gear set (800) and the first driving unit (101), the second transmission (302) transmits the rotary kinetic energy between the umbrella-type planetary gear power transmission rocker arm (804) of the differential gear set (800) and the second driving unit (201), and one or both of the transmissions drives the umbrella-type planetary gear power transmission rocker arm (804) of the differential gear set (800) to transmit the rotary kinetic energy, and thereby drives the differential output shafts (311) and (312) to implement differential output operation.

For the dual gear train driving structure at input side of basin-type gear, the second driving unit (201) is used for the operations of the motor and/or the power generation function through powered electric machinery, or the fluid force rotary driving unit driven by hydraulic pressure or atmospheric pressure, or the rotary driving unit driven by flywheel, or spring, or human power, or animal power, or wind power, or water potential energy, or fluid power is used to be the second driving unit.

FIG. 2 is a structural schematic diagram showing the main components of the dual gear train driving structure at input side of basin-type gear, according to the present invention.

As shown in FIG. 2, except for the first driving unit (101) and the second driving unit (201), the former is constituted by the rotary power source driven by internal combustion engine, or external combustion engine, or electric machinery, or hydraulic pressure, or atmospheric pressure, or spring, or flywheel, or human power, or animal power, or wind power, or water potential energy, or fluid power, and the later is constituted by the rotary power source driven by internal combustion engine, or external combustion engine, or electric machinery, or hydraulic pressure, or atmospheric pressure, or spring, or flywheel, or human power, or animal power, or wind power, or water potential energy, or fluid power, the main components including:

differential gear set assembly (300): constituted by gear, or friction wheel, or pulley, or sprocket, or CVT, in which the first transmission (301) is used to directly or through the controllable clutch unit (CL101) and/or transmission transmit the rotary kinetic energy between the first driving unit (101) and the umbrella-type planetary gear power transmission rocker arm (804) of the differential gear set (800), the second transmission (302) is used to transmit the rotary kinetic energy between the second driving unit (201) and the umbrella-type planetary gear power transmission rocker arm (804) of the differential gear set (800), and the differential gear set (800) is installed with the differential output shaft (311) and the differential output shaft (312) to coaxially output externally, and the case and the bearing of the differential gear set assembly are included;

controllable clutch unit (CL101): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;

differential gear set (800): related to umbrella-type differential gear constituted by umbrella-type gear or umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804);

first transmission (301): related to a transmission constituted by gear, or friction wheel, or pulley and transmission belt, or CVT wheel and transmission belt, or sprocket and transmission chain, including the structure of parallel input shaft and output shaft transmission, or non-parallel angle axis transmission, in which the input terminal of the first transmission is driven by the first driving unit (101), and the driving wheel of the first transmission drives the umbrella-type planetary gear power transmission rocker arm (804) of the differential gear set (800);

second transmission (302): related to a transmission constituted by gear, or friction wheel, or pulley and transmission belt, or CVT wheel and transmission belt, or sprocket and transmission chain, including the structure of parallel input shaft and output shaft transmission, or non-parallel angle axis transmission, in which the input terminal of the second transmission is driven by the second driving unit (202), and the driving wheel of the second transmission drives the umbrella-type planetary gear power transmission rocker arm (804) of the differential gear set (800); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

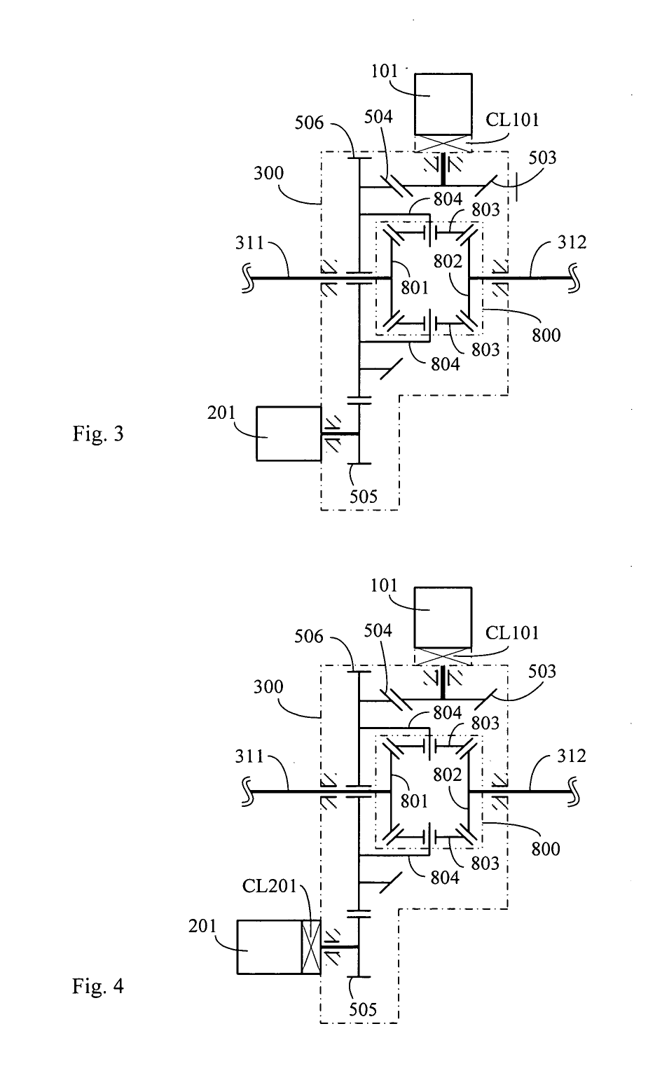

FIG. 3 is a structural schematic diagram showing that the rotary part of electric machinery constituting single set of the second driving unit (201) drives the transmission gear of the second transmission (506) through second transmission input gear (505), and along with the basin-type bevel gear of the first transmission (504) individually or together drive the umbrella-type planetary gear power transmission rocker arm (804), according to the present invention.

As shown in FIG. 3, except for the rotary power source driven by the internal combustion engine constituting the first driving unit (101), and the rotary power source driven by the electric machinery constituting the second driving unit (201), the main components including:

differential gear set assembly (300): including the first transmission (301), constituted by the first transmission input bevel gear (503) and the basin-type bevel gear of the first transmission (504), which is used to directly or through the controllable clutch unit (CL101) and/or the transmission transmit the rotary kinetic energy between the first driving unit (101) and the umbrella-type planetary gear power transmission rocker arm (804) of the differential gear set (800), and including the second transmission (302), constituted by the second transmission input gear (505) and the transmission gear of the second transmission (506), which is used to transmit the rotary kinetic energy between the second driving unit (201) and the umbrella-type planetary gear power transmission rocker arm (804) of the differential gear set (800), and the differential gear set (800) is installed with the differential output shaft (311) and the differential output shaft (312) to coaxially output externally, and the case and the bearing of the differential gear set assembly are included;

controllable clutch unit (CL101): constituted by clutch unit or structure capable of implementing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;

differential gear set (800): related to umbrella-type differential gear constituted by umbrella-type gear or umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

FIG. 4 is a structural schematic diagram showing the embodiment that the clutch unit (CL201) is installed between the output terminal of the rotary part of the electric machinery constituting single set of the second driving unit (201) and the second transmission input gear (505) in FIG. 3.

As shown in FIG. 4, the controllable clutch unit (CL201) is installed between the output terminal of the rotary part of the electric machinery constituting single set of the second driving unit (201) and the second transmission input gear (505) in the embodiment of FIG. 3, to control the engaged or disengaged operation between the output terminal of the rotary part of the electric machinery and the second transmission input gear (505).

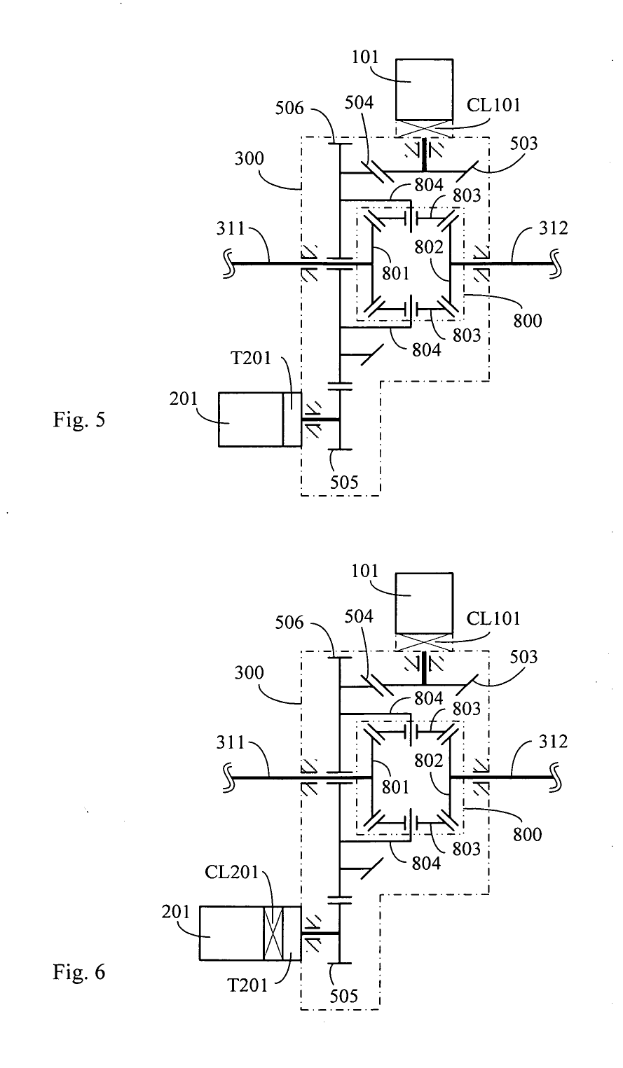

FIG. 5 is a structural schematic diagram showing the embodiment that a speed variable transmission (T201) is installed between the output terminal of the rotary part of the electric machinery constituting single set of the second driving unit (201) and the second transmission input gear (505) in FIG. 3.

As shown in FIG. 5, the speed variable transmission (T201) is installed between the output terminal of the rotary part of the electric machinery constituting single set of the second driving unit (201) and the second transmission input gear (505) in the embodiment of FIG. 3 to change the speed ratio between the rotary part of the electric machinery and the second transmission input gear (505).

FIG. 6 is a structural schematic diagram showing the embodiment that the output terminal of the rotary part of the electric machinery constituting single set of the second driving unit (201) in FIG. 3 is through the clutch unit (CL201) and then through the speed variable transmission (T201) connected to the second transmission input gear (505).

As shown in FIG. 6, the output terminal of the rotary part of the electric machinery constituting single set of the second driving unit (201) in the embodiment of FIG. 3 further through the clutch unit (CL201) and then through the speed variable transmission (T201) connects to the second transmission input gear (505), so as by means of the controllable clutch unit (CL201) to control the engaged or disengaged operation between the output terminal of the rotary part of the electric machinery and the speed variable transmission (T201), and by means of the second driving unit (201) to change the speed ratio between the output terminal of the rotary part of the electric machinery and the second transmission input gear (505) through.

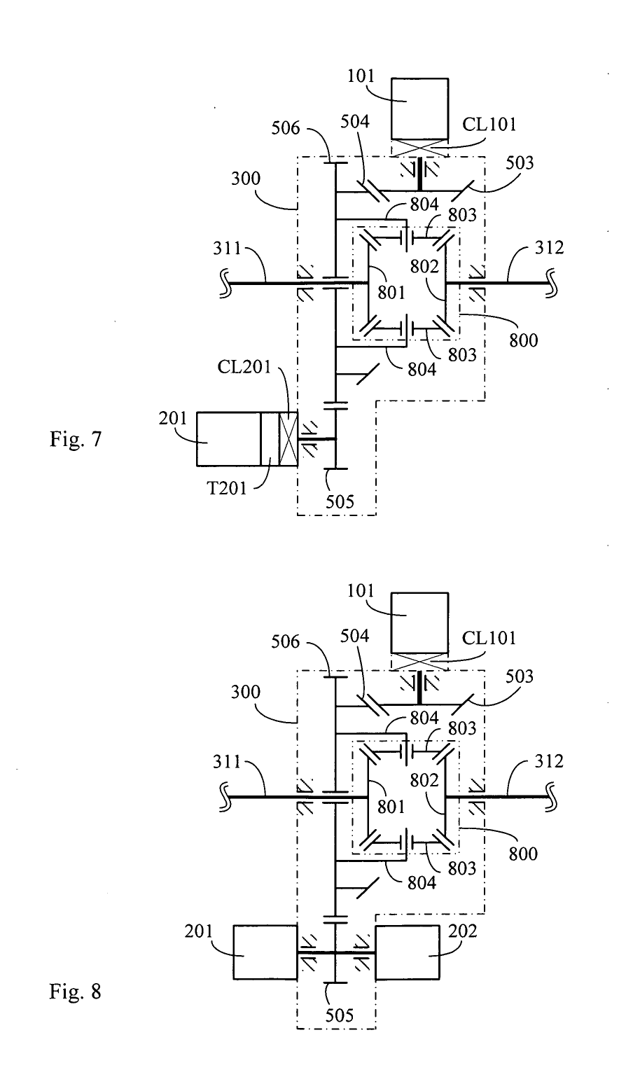

FIG. 7 is a structural schematic diagram showing the embodiment that two sets of the output terminals of the rotary part of the electric machinery constituting the second driving unit (201) in FIG. 3 is through the speed variable transmission (T201) and then through the controllable clutch unit (CL201) connected to the second transmission input gear (505) in FIG. 3.

As shown in FIG. 7, two sets of the output terminals of the rotary part of the electric machinery constituting the second driving unit (201) in the embodiment of FIG. 3 is through the speed variable transmission (T201) and then through the controllable clutch unit (CL201) connected to the second transmission input gear (505), and by means of the speed variable transmission (T201) to change the speed ratio between the output terminal of the rotary part of the electric machinery and the input terminal of the controllable clutch unit (CL201), and by means of the controllable clutch unit (CL201) to control the engaged or disengaged operation between the output terminal of the speed variable transmission (T201) and the second transmission input gear (505).

FIG. 8 is a structural schematic diagram showing the embodiment that two electric machineries constituting the second driving units (201) and (202) are further installed to the embodiment of FIG. 3 for commonly driving the input terminal of the second transmission (302), according to the present invention.

As shown in FIG. 8, two electric machineries are further installed to the embodiment of FIG. 3, thus the rotary power sources driven by the two electric machineries constitute the second driving units (201) and (202), thereby by means of two or one of the electric machineries to drive the second transmission input gear (505).

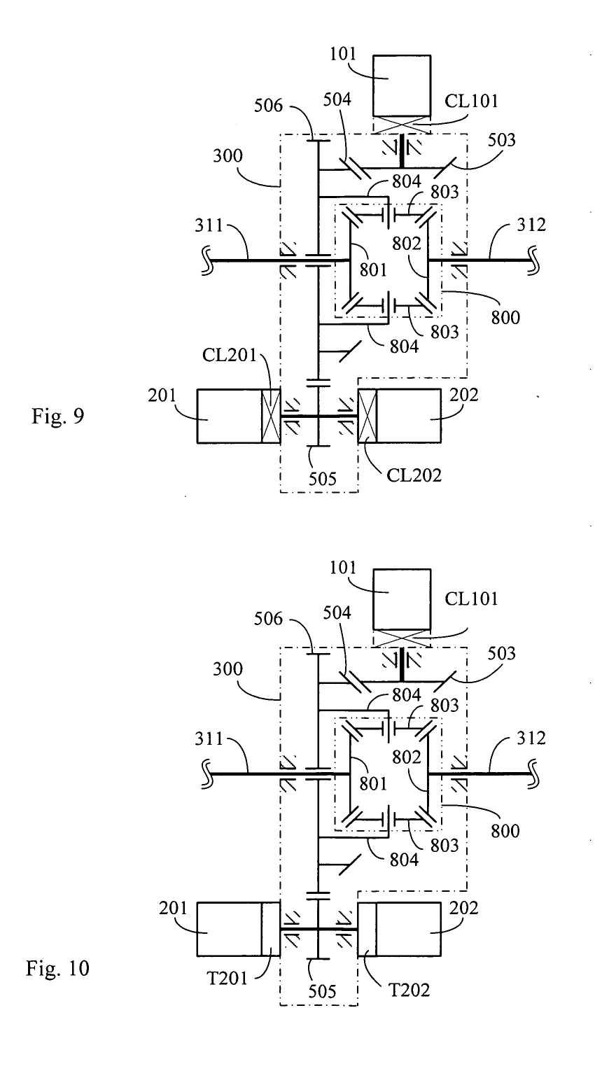

FIG. 9 is a structural schematic diagram showing the embodiment that two electric machineries constituting the second driving units (201) and (202) are further installed to the embodiment of FIG. 4, and the two controllable clutch units (CL201) and (CL202) are individually installed between each of the output terminals of the rotary parts of the two electric machineries and the second transmission input gear (505).

As shown in FIG. 9, two electric machineries are further installed to the embodiment of FIG. 4, thus the rotary power sources driven by the two electric machineries constitute the second driving units (201) and (202), and the two controllable clutch units (CL201) and (CL202) are individually installed between each of the output terminals of the rotary parts of the two electric machineries and the second transmission input gear (505), thereby by means of two or one of the electric machineries to drive the second transmission input gear (505).

FIG. 10 is a structural schematic diagram showing the embodiment that two electric machineries constituting the second driving units (201) and (202) are further installed to the embodiment of FIG. 5, and the two speed variable transmissions (T201) and (T202) are individually installed between each of the output terminals of the rotary parts of the two electric machineries and the second transmission input gear (505).

As shown in FIG. 10, two electric machineries are further installed to the embodiment of FIG. 5, thus the rotary power sources driven by the two electric machineries constitute the second driving units (201) and (202), and the two speed variable transmissions (T201) and (T202) are individually installed between each of the output terminals of the rotary parts of the two electric machineries and the second transmission input gear (505), thereby by means of two or one of the electric machineries to drive the second transmission input gear (505).

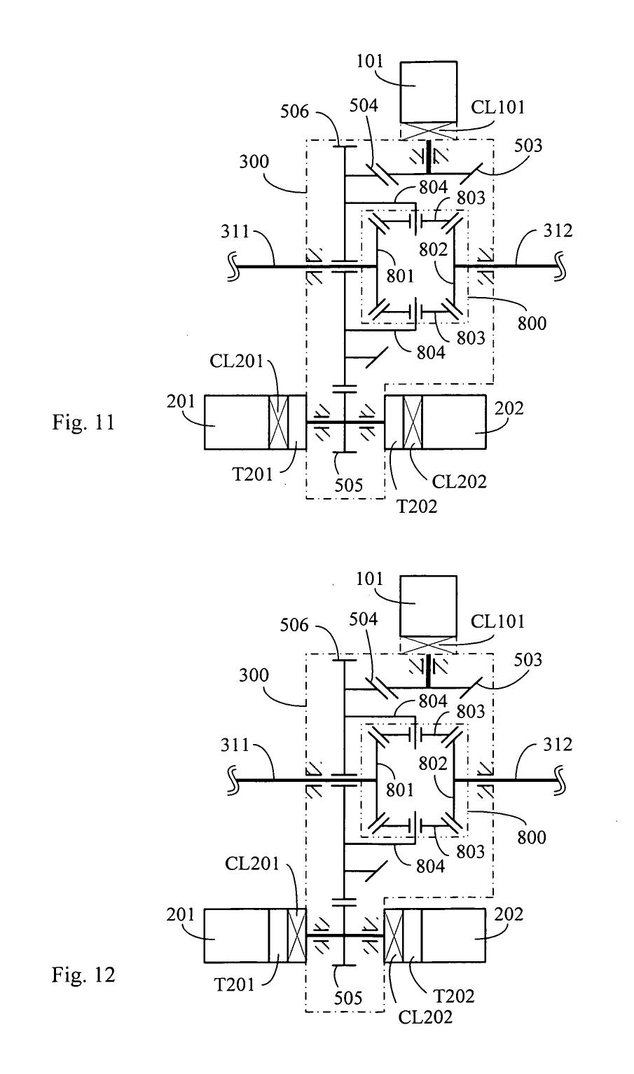

FIG. 11 is a structural schematic diagram showing the embodiment that two electric machineries constituting the second driving units (201) and (202) are further installed to the embodiment of FIG. 6, and the output terminals of the rotary parts of the two electric machineries are individually through the controllable clutch units (CL201) and (CL202) and then through the speed variable transmissions (T201) and (T202) connected to the second transmission input gear (505).

As shown in FIG. 11, two electric machineries are further installed to the embodiment of FIG. 6, thus the rotary power sources driven by the two electric machineries constitute the second driving units (201) and (202), and the output terminals of the rotary parts of the two electric machineries are individually through the controllable clutch units (CL201) and (CL202) and then through the speed variable transmissions (T201) and (T202) connected to the second transmission input gear (505), thereby by means of two or one of the electric machineries to drive the second transmission input gear (505).

FIG. 12 is a structural schematic diagram showing the embodiment that two electric machineries constituting the second driving units (201) and (202) are further installed in the embodiment of FIG. 7, and the output terminals of the rotary parts of the two electric machineries are individually through the speed variable transmissions (T201) and (T202) and then through the controllable clutch units (CL201) and (CL202) connected to the second transmission input gear (505).

As shown in FIG. 12, two electric machineries are further installed to the embodiment of FIG. 7, thus the rotary power sources driven by the two electric machineries constitute the second driving units (201) and (202), and the output terminals of the rotary parts of the two electric machineries are individually through the speed variable transmissions (T201) and (T202) and then through the controllable clutch units (CL201) and (CL202) connected to the second transmission input gear (505), thereby by means of two or one of the electric machineries to drive the second transmission input gear (505).

As for the above embodiments in FIG. 3 to FIG. 12, the umbrella-type planetary gear set (803) and the umbrella-type planetary gear power transmission rocker arm (804) constitute the first transmission (301), and the second transmission input gear (505) and the transmission gear of the second transmission (506) constitute the second transmission (302), but for the dual gear train driving structure at input side of basin-type gear, the constitutions of the first transmission (301) and the second transmission (302) do not limit to the above-mentioned, which have following choices as application requirements.

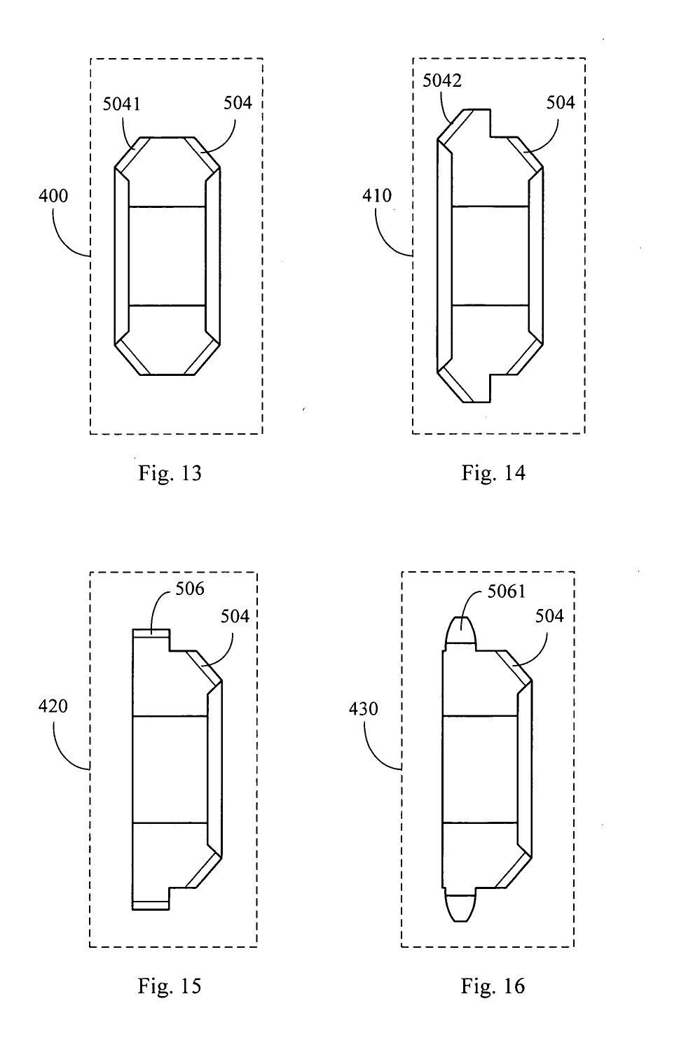

FIG. 13 is a structural schematic diagram showing the embodiment of integrated dual basin-type bevel gear set with same outer diameter (400).

As shown in FIG. 13, the basin-type bevel gear of the first transmission (504) and the basin-type bevel gear of the second transmission (5041) are made as an integral structure, or are through welding or melting to become an integral structure to constitute the integrated dual basin-type bevel gear set with same outer diameter (400), in which the basin-type bevel gear of the first transmission (504) and the basin-type bevel gear of the second transmission (5041) have same outer diameter while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5041) is used for along with the corresponding second transmission input bevel gear constituting the second transmission (302).

FIG. 14 is a structural schematic diagram showing the embodiment of integrated dual basin-type bevel gear set with different outer diameters (410), according to the present invention.

As shown in FIG. 14, the basin-type bevel gear of the first transmission (504) and the basin-type bevel gear of the second transmission (5042) are made as an integral structure, or are through welding or melting to become an integral structure to constitute the integrated dual basin-type bevel gear set with different outer diameters (410), in which the basin-type bevel gear of the first transmission (504) and the basin-type bevel gear of the second transmission (5042) have different outer diameters, including the outer diameter of the basin-type bevel gear of the first transmission (504) is larger or less than that of the basin-type bevel gear of the second transmission (5042), while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5042) is used for along with the corresponding second transmission input bevel gear constituting the second transmission (302).

FIG. 15 is a structural schematic diagram showing the embodiment of integrated transmission gear and bevel gear set (420), according to the present invention.

As shown in FIG. 15, the basin-type bevel gear of the first transmission (504) and the transmission gear of the second transmission (506) are made as an integral structure, or are through welding or melting to become an integral structure to constitute the integrated transmission gear and bevel gear set (420), in which the basin-type bevel gear of the first transmission (504) is used for along with the first transmission input bevel gear (503) constituting the first transmission (301), and the transmission gear of the second transmission (506) is used for along with the relative second transmission input gear (505) constituting the second transmission (302).

FIG. 16 is a structural schematic diagram showing the embodiment of integrated transmission sprocket and basin-type bevel gear set (430), according to the present invention.

As shown in FIG. 16, the basin-type bevel gear of the first transmission (504) and the transmission sprocket of the second transmission (5061) are made as an integral structure, or are through welding or melting to become an integral structure to constitute the integrated transmission sprocket and basin-type bevel gear set (430), in which the basin-type bevel gear of the first transmission (504) is used for along with the first transmission input bevel gear (503) constituting the first transmission (301), and the transmission sprocket of the second transmission (5061) is used for along with the corresponding second transmission input sprocket and transmission chain constituting the second transmission (302).

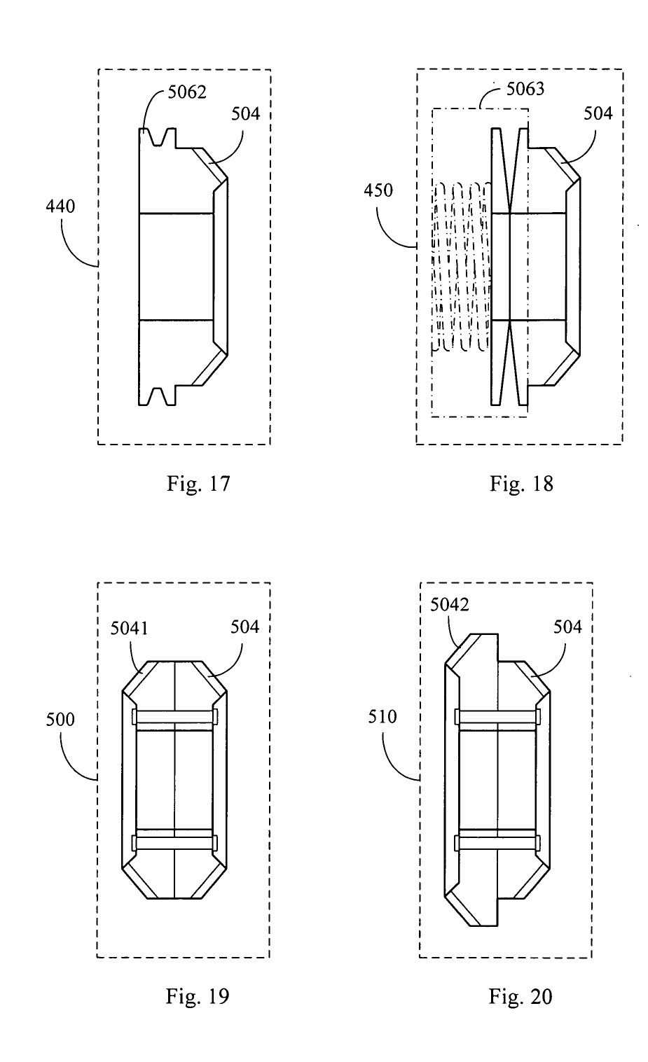

FIG. 17 is a structural schematic diagram showing the embodiment of integrated transmission pulley and basin-type bevel gear set (440), according to the present invention.

As shown in FIG. 17, the basin-type bevel gear of the first transmission (504) and the transmission pulley of the second transmission (5062) are made as an integral structure, or are through welding or melting to become an integral structure to constitute the integrated transmission pulley and basin-type bevel gear set (440), in which the basin-type bevel gear of the first transmission (504) is used for along with the first transmission input bevel gear (503) constituting the first transmission (301), and the transmission pulley of the second transmission (5062) is used for along with the corresponding second transmission input pulley and transmission belt constituting the second transmission (302).

FIG. 18 is a structural schematic diagram showing the embodiment of integrated transmission CVT wheel and basin-type bevel gear set (450), according to the present invention.

As shown in FIG. 18, the basin-type bevel gear of the first transmission (504) and the transmission CVT wheel of the second transmission (5063) are made as an integral structure, or are through welding or melting to become an integral structure to constitute the integrated transmission CVT wheel and basin-type bevel gear set (450), in which the basin-type bevel gear of the first transmission (504) is used for along with the first transmission input bevel gear (503) constituting the first transmission (301), and the transmission CVT wheel of the second transmission (5063) is used for along with the corresponding second transmission input CVT wheel and CVT wheel transmission belt constituting the second transmission (302).

FIG. 19 is a structural schematic diagram showing the embodiment of combined dual basin-type bevel gear set with same outer diameter (500), according to the present invention.

As shown in FIG. 19, the combined dual basin-type bevel gear set with same outer diameter (500) is constituted by the combination of the basin-type bevel gear of the first transmission (504) and the basin-type bevel gear of the second transmission (5041), including the combined structure through screws locking, or riveting, or fastening, or lamination, or embedding, in which the basin-type bevel gear of the first transmission (504) and the basin-type bevel gear of the second transmission (5041) in the combined structure have the same outer diameter while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5041) is used for along with the corresponding second transmission input bevel gear constituting the second transmission (302).

FIG. 20 is a structural schematic diagram showing the embodiment of combined dual basin-type bevel gear set with different outer diameters (510), according to the present invention.

As shown in FIG. 20, the combined dual basin-type bevel gear set with different outer diameter (510) is constituted by the combination of the basin-type bevel gear of the first transmission (504) and the basin-type bevel gear of the second transmission (5042), including the combined structure through screws locking, or riveting, or fastening, or lamination, or embedding, in which the basin-type bevel gear of the first transmission (504) and the basin-type bevel gear of the second transmission (5042) in the combined structure have different outer diameters, including the outer diameter of the basin-type bevel gear of the first transmission (504) is larger or less than that of the basin-type bevel gear of the second transmission (5042) while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5042) is used for along with the corresponding second transmission input bevel gear constituting the second transmission (302).

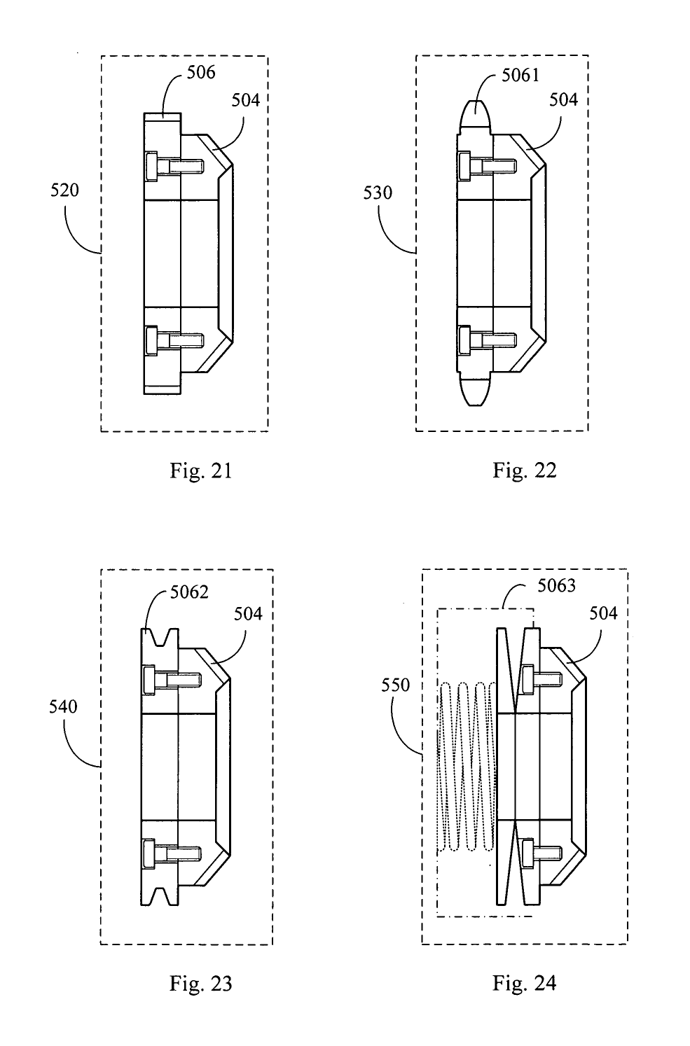

FIG. 21 is a structural schematic diagram showing the embodiment of combined transmission gear and basin-type bevel gear set (520), according to the present invention.

As shown in FIG. 21, the combined transmission gear and basin-type bevel gear set (520) is constituted by the combination of the basin-type bevel gear of the first transmission (504) and the transmission gear of the second transmission (506), including the combined structure through screws locking, or riveting, or fastening, or lamination, or embedding, in which the basin-type bevel gear of the first transmission (504) is used for along with the first transmission input bevel gear (503) constituting the first transmission (301), and the transmission gear of the second transmission (506) is used for along with the corresponding second transmission input gear (505) constituting the second transmission (302).

FIG. 22 is a structural schematic diagram showing the embodiment of combined transmission sprocket and basin-type bevel gear set (530), according to the present invention.

As shown in FIG. 22, the combined transmission sprocket and basin-type bevel gear set (530) is constituted by the combination of the basin-type bevel gear of the first transmission (504) and the transmission sprocket of the second transmission (5061), including the combined structure through screws locking, or riveting, or fastening, or lamination, or embedding, in which the basin-type bevel gear of the first transmission (504) is used for along with the first transmission input bevel gear (503) constituting the first transmission (301), and the transmission sprocket of the second transmission (5061) is used for along with the corresponding second transmission input sprocket and transmission chain constituting the second transmission (302).

FIG. 23 is a structural schematic diagram showing the embodiment of combined transmission pulley and basin-type bevel gear set (540), according to the present invention.

As shown in FIG. 23, the combined transmission pulley and basin-type bevel gear set (540) is constituted by the combination of the basin-type bevel gear of the first transmission (504) and the transmission pulley of the second transmission (5062), including the combined structure through screws locking, or riveting, or fastening, or lamination, or embedding, in which the basin-type bevel gear of the first transmission (504) is used for along with the first transmission input bevel gear (503) constituting the first transmission (301), and the transmission pulley of the second transmission (5062) is used for along with the corresponding second transmission input pulley and transmission belt constituting the second transmission (302).

FIG. 24 is a structural schematic diagram showing the embodiment of combined transmission CVT wheel and basin-type bevel gear set (550), according to the present invention.

As shown in FIG. 24, the combined transmission CVT wheel and basin-type bevel gear set (550) is constituted by the combination of the basin-type bevel gear of the first transmission (504) and the transmission CVT wheel of the second transmission (5063), including the combined structure through screws locking, or riveting, or fastening, or lamination, or embedding, in which the basin-type bevel gear of the first transmission (504) is used for along with the first transmission input bevel gear (503) constituting the first transmission (301), and the transmission CVT wheel of the second transmission (5063) is used for along with the corresponding second transmission input CVT wheel and CVT wheel transmission belt constituting the second transmission (302).

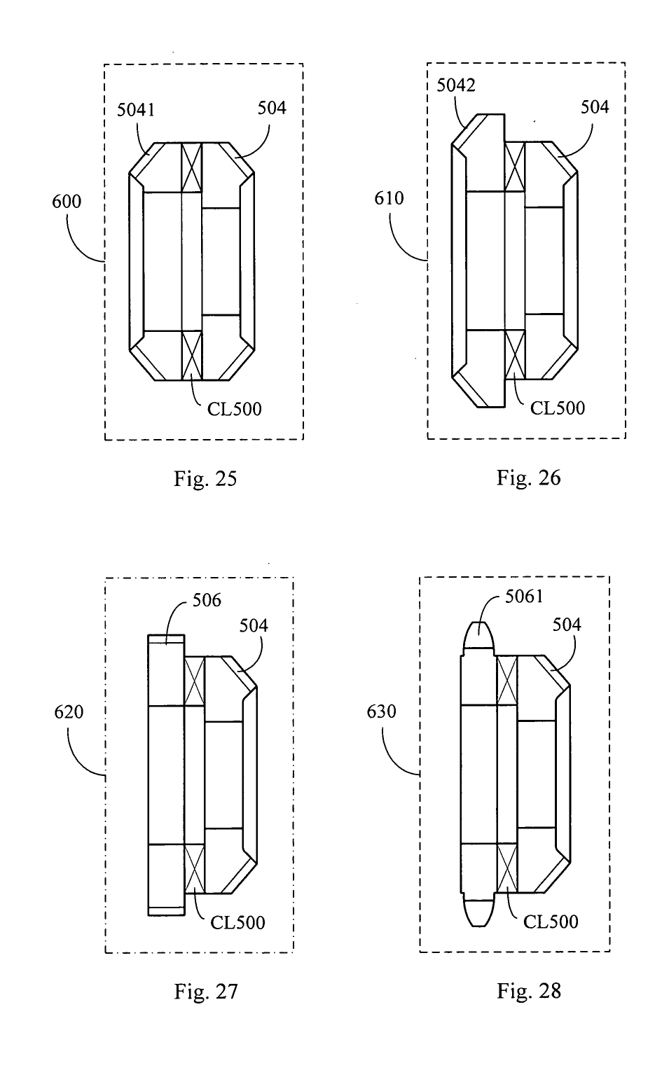

FIG. 25 is a structural schematic diagram showing the embodiment of dual basin-type bevel gear set (600) with same outer diameter and with the clutch unit (CL500), according to the present invention.

As shown in FIG. 25, the controllable clutch unit (CL500) is installed between the basin-type bevel gear of the first transmission (504) and the basin-type bevel gear of the second transmission (5041) to constitute the dual basin-type bevel gear set (600) with same outer diameter and clutch unit (CL500), in which the basin-type bevel gear of the first transmission (504) and the basin-type bevel gear of the second transmission (5041) have same outer diameter while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5041) is used for along with the corresponding second transmission input bevel gear constituting the second transmission (302); moreover, the engagement or disengagement between the basin-type bevel gear of the second transmission (5041) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, is equipped with the rotary input side and the rotary output side.

FIG. 26 is a structural schematic diagram showing the embodiment of dual basin-type bevel gear set with different outer diameters (610) and with the clutch unit (CL500), according to the present invention.

As shown in FIG. 26, the controllable clutch unit (CL500) is installed between the basin-type bevel gear of the first transmission (504) and the basin-type bevel gear of the second transmission (5042) to constitute the dual basin-type bevel gear set with different outer diameters (610) and clutch unit (CL500), in which the basin-type bevel gear of the first transmission (504) and the basin-type bevel gear of the second transmission (5042) have different outer diameters, including the outer diameter of the basin-type bevel gear of the first transmission (504) is larger or less than that of the basin-type bevel gear of the second transmission (5042) while the tooth type, and/or the gear modulus, and/or the tooth number can be the same or different; the basin-type bevel gear of the first transmission (504) is used for along with the first transmission input bevel gear (503) constituting the first transmission (301), and the basin-type bevel gear of the second transmission (5042) is used for along with the corresponding second transmission input bevel gear constituting the second transmission (302); moreover, the engagement or disengagement between the basin-type bevel gear of the second transmission (5042) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

FIG. 27 is a structural schematic diagram showing the embodiment of the transmission gear and basin-type bevel gear set (620) with the clutch unit (CL500), according to the present invention.

As shown in FIG. 27, the controllable clutch unit (CL500) is installed between the basin-type bevel gear of the first transmission (504) and the transmission gear of the second transmission (506) to constitute the transmission gear and basin-type bevel gear set (620) with the clutch unit (CL500), in which the basin-type bevel gear of the first transmission (504) is used for along with the first transmission input bevel gear (503) constituting the first transmission (301), and the transmission gear of the second transmission (506) is used for along with the relative second transmission input gear (505) constituting the second transmission (302); the engagement or disengagement between the transmission gear of the second transmission (506) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

FIG. 28 is a structural schematic diagram showing the embodiment of the transmission sprocket and basin-type bevel gear set (630) with the clutch unit (CL500), according to the present invention.

As shown in FIG. 28, the controllable clutch unit (CL500) is installed between the basin-type bevel gear of the first transmission (504) and the transmission sprocket of the second transmission (5061) to constitute the transmission sprocket and basin-type bevel gear set (630) with the clutch unit (CL500), in which the basin-type bevel gear of the first transmission (504) is used for along with the first transmission input bevel gear (503) constituting the first transmission (301), and the transmission sprocket of the second transmission (5061) is used for along with the corresponding second transmission input sprocket and transmission chain constituting the second transmission (302); the engagement or disengagement between the transmission sprocket of the second transmission (5061) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

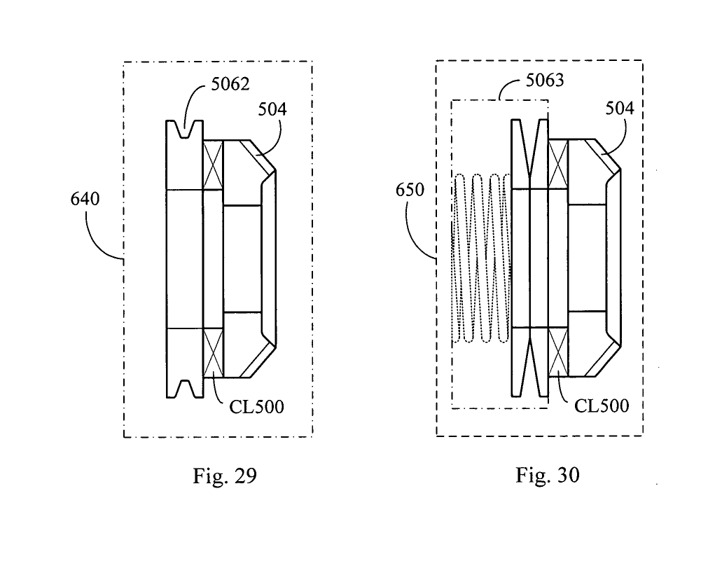

FIG. 29 is a structural schematic diagram showing the embodiment of the transmission pulley and basin-type bevel gear set (640) with the clutch unit (CL500), according to the present invention.

As shown in FIG. 29, the controllable clutch unit (CL500) is installed between the basin-type bevel gear of the first transmission (504) and the transmission pulley of the second transmission (5062) to constitute the transmission pulley and basin-type bevel gear set (640) with the clutch unit (CL500), in which the basin-type bevel gear of the first transmission (504) is used for along with the first transmission input bevel gear (503) constituting the first transmission (301), and the transmission gear of the second transmission (506) is used for along with the corresponding second transmission input pulley and transmission belt constituting the second transmission (302); the engagement or disengagement between the transmission pulley of the second transmission (5062) and the basin-type bevel gear of the first transmission (504) is controlled by the controllable clutch unit (CL500); and the controllable clutch unit (CL500) constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

FIG. 30 is a structural schematic diagram showing the embodiment of the transmission CVT wheel and basin-type bevel gear set (650) with the clutch unit (CL500), according to the present invention.

As shown in FIG. 30, the controllable clutch unit (CL500) is installed between the basin-type bevel gear of the first transmission (504) and the transmission CVT wheel of the second transmission (5063) to constitute the transmission CVT wheel and basin-type bevel gear set (650) with the clutch unit (CL500), in which the basin-type bevel gear of the first transmission (504) is used for along with the first transmission input bevel gear (503) constituting the first transmission (301), and the transmission CVT wheel of the second transmission (5063) is used for along with the relative second transmission input CVT wheel and CVT wheel transmission belt constituting the second transmission (302); the engagement or disengagement between the transmission CVT wheel of the second transmission (5063) and the transmission gear of the second transmission (506) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

The following are embodiments of the dual gear train driving structure at input side of basin-type gear of the present invention, in which the controllable clutch unit (CL500) is installed within the differential gear set assembly (300).

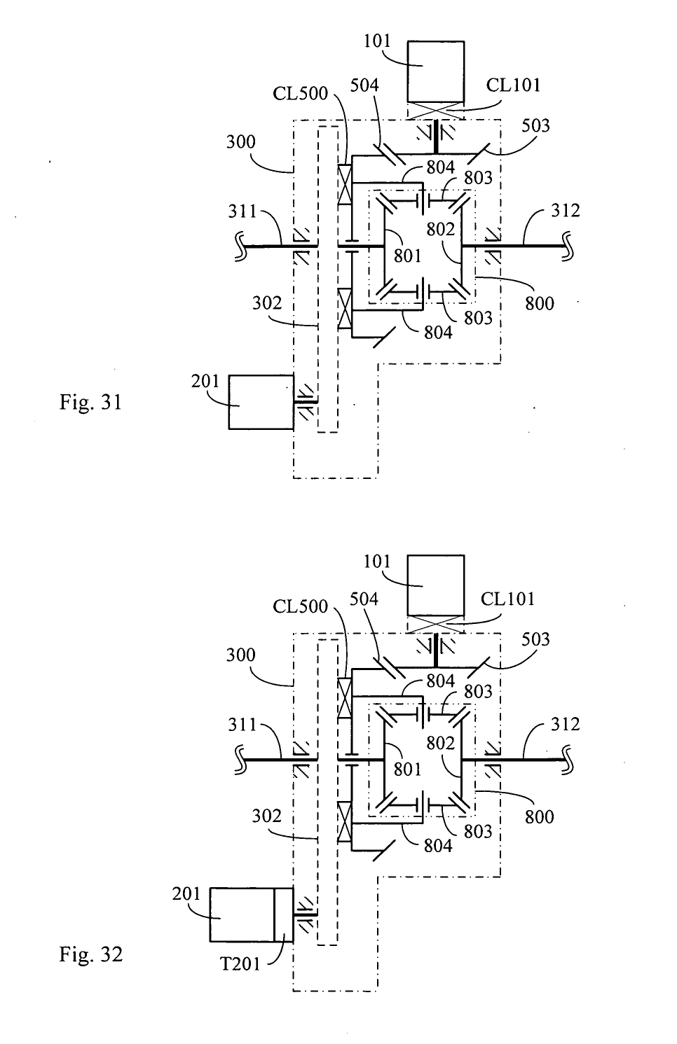

FIG. 31 is a structural schematic diagram showing the embodiment that the output terminal of the rotary part of electric machinery constituting the single set of the second driving unit (201) couples with the basin-type bevel gear of the first transmission (504) through the second transmission (302) and the controllable clutch unit (CL500), and then connects with the umbrella-type planetary gear power transmission rocker arm (804), according to the present invention.

As shown in FIG. 31, except for the rotary power source driven by the internal combustion engine constituting the first driving unit (101), and the rotary power source driven by the electric machinery constituting the second driving unit (201), the main components including:

differential gear set assembly (300): the controllable clutch unit (CL500) is installed between the driving wheel group of the first transmission and the driving wheel group of the second transmission for controlling the engaged or disengaged operation; in which the first transmission input bevel gear (503) and the basin-type bevel gear of the first transmission (504) constitutes the first transmission (301), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804); and/or the rotary kinetic energy of the second driving unit (201) drives the umbrella-type planetary gear power transmission rocker arm (804) of the differential gear set (800) through the second transmission (302) and the controllable clutch unit (CL500); and the differential gear set (800) is installed with the differential output shaft (311) and the differential output shaft (312) to coaxially output externally, and the case and the bearing of differential gear set assembly are included;

controllable clutch units (CL101), (CL500): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, is equipped with the rotary input side and the rotary output side;

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

FIG. 32 is a structural schematic diagram showing the embodiment that the speed variable transmission (T201) is installed between the output terminal of the rotary part in the second driving unit (201) and the input terminal of the second transmission (302) in FIG. 31, and the second transmission (302) and the controllable clutch unit (CL500) couple with the basin-type bevel gear of the first transmission (504), and then connect to the umbrella-type planetary gear power transmission rocker arm (804), according to the present invention.

As shown in FIG. 32, the speed variable transmission (T201) is installed between the output terminal of the rotary part in the second driving unit (201) and the input terminal of the second transmission (302) in the embodiment of FIG. 31, to change the speed ratio between the output terminal of the second driving unit (201) and the input terminal of the second transmission (302).

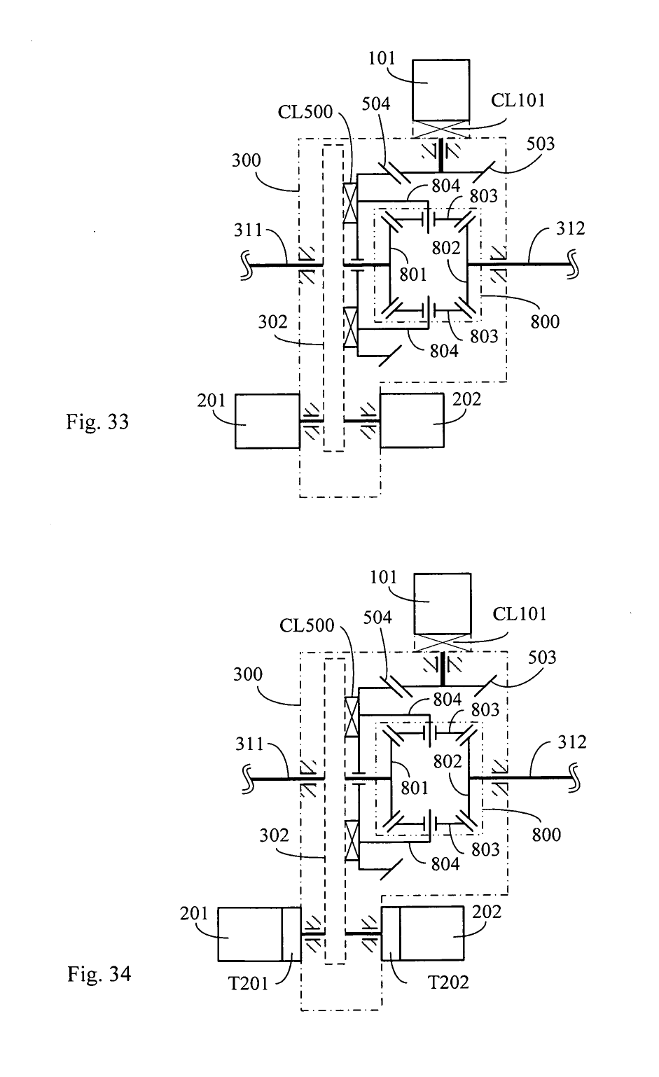

FIG. 33 is a structural schematic diagram showing the embodiment that two electric machineries are further installed to the embodiment of FIG. 31 to constitute the second driving units (201) and (202) to together drive the input terminal of the second transmission (302), according to the present invention.

As shown in FIG. 33, two electric machineries are further installed to the embodiment of FIG. 31 to constitute the second driving units (201) and (202), and by means of two or one of the electric machineries to drive the input terminal of the second transmission (302).

FIG. 34 is a structural schematic diagram showing the embodiment that two electric machineries are further installed to constitute the second driving units (201) and (202), and the speed variable transmission (T201) and the speed variable transmission (T202) are installed, according to the present invention.

As shown in FIG. 34, the two electric machineries further constitute the second driving units (201) and (202) in the embodiment of FIG. 32, and two or one of the electric machineries respectively through the speed variable transmission (T201) and the speed variable transmission (T202) drive the input terminal of the second transmission (302), according to the present invention.

For the dual gear train driving structure at input side of basin-type gear, the umbrella-type planetary gear power transmission rocker arm (804) is further installed at both sides of the differential gear set (800), in which one side of the umbrella-type planetary gear power transmission rocker arm (804) combines with the basin-type bevel gear of the first transmission (504), and the other side couples with the second transmission (302) through the controllable clutch unit (CL500), so as to control the engaged transmission or disengagement between the second transmission (302) and the differential gear set (800).

The followings are various embodiments of the present invention that the umbrella-type planetary gear power transmission rocker arm (804) is installed at two sides of the differential gear set (800), in which one side of the umbrella-type planetary gear power transmission rocker arm (804) combines with the basin-type bevel gear of the first transmission (504), and the other side couples with the second transmission (302) through the controllable clutch unit (CL500).

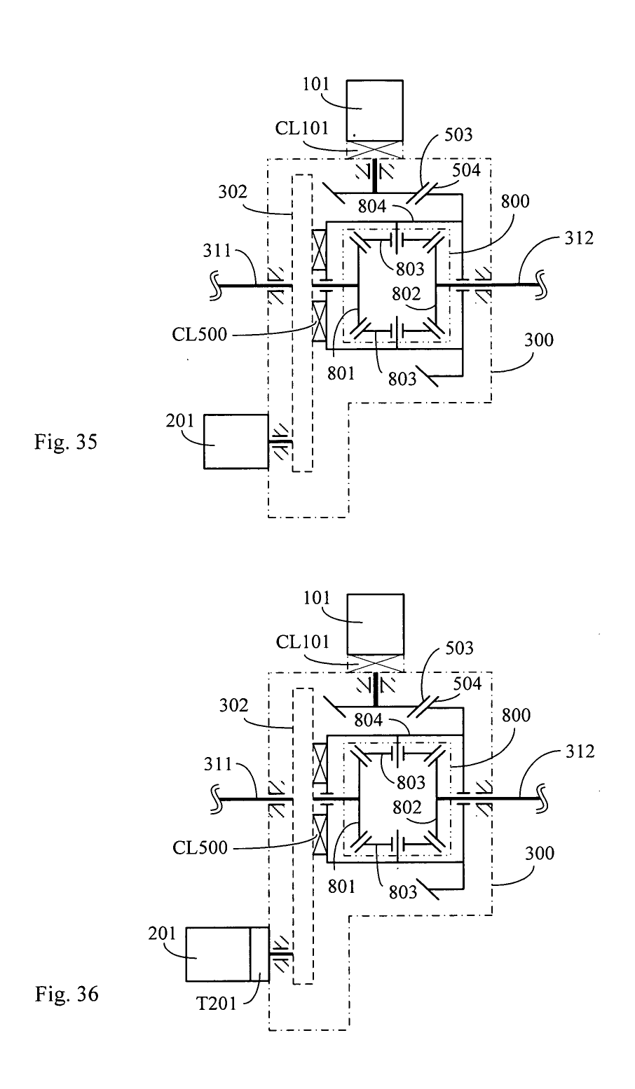

FIG. 35 is a structural schematic diagram showing the embodiment that the second transmission (302) driven by the output terminal of the rotary part of the electric machinery constituting the single set of the second driving unit (201) combines with the umbrella-type planetary gear power transmission rocker arm (804) at left side of the differential gear set (800) through the controllable clutch unit (CL500), while the umbrella-type planetary gear power transmission rocker arm (804) at right side rightward extends and combines with the basin-type bevel gear of the first transmission (504), and is subject to be driven by the first driving unit (101) through the first transmission input bevel gear (503), according to the present invention.

As shown in FIG. 35, except for the rotary power source driven by the internal combustion engine constituting the first driving unit (101), and the rotary power source driven by the electric machinery constituting the second driving unit (201), the main components including:

differential gear set assembly (300): the controllable clutch unit (CL500) is installed between the driving wheel group of the second transmission (302) and the umbrella-type planetary gear power transmission rocker arm (804) for controlling the engaged or disengaged operation; in which the first transmission input bevel gear (503) and the basin-type bevel gear of the first transmission (504) constitutes the first transmission (301), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804); and/or the rotary kinetic energy of the second driving unit (201) drives the umbrella-type planetary gear power transmission rocker arm (804) of the differential gear set (800) through the second transmission (302) and the controllable clutch unit (CL500); and the differential gear set (800) is installed with the differential output shaft (311) and the differential output shaft (312) to coaxially output externally, and is equipped with the the case and the bearing of differential gear set assembly;

controllable clutch units (CL101), (CL500): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, is equipped with the rotary input side and the rotary output side;

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) through the umbrella-type planetary gear power transmission rocker arm (804), and/or transmits the rotary kinetic energy between the second transmission (302) and the umbrella-type planetary gear power transmission rocker arm (804) through the controllable clutch unit (CL500); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation;

FIG. 36 is a structural schematic diagram showing the embodiment that the speed variable transmission (T201) is installed between the output terminal of the rotary part of electric machinery in the second driving unit (201) and the input terminal of the second transmission (302) in the embodiment of FIG. 35, according to the present invention.

As shown in FIG. 36, the speed variable transmission (T201) is installed between the output terminal of the rotary part of electric machinery in the second driving unit (201) and the input terminal of the second transmission (302) in the embodiment of FIG. 35 to change the speed ratio between the output terminal of the second driving unit (201) and the input terminal of the second transmission (302).

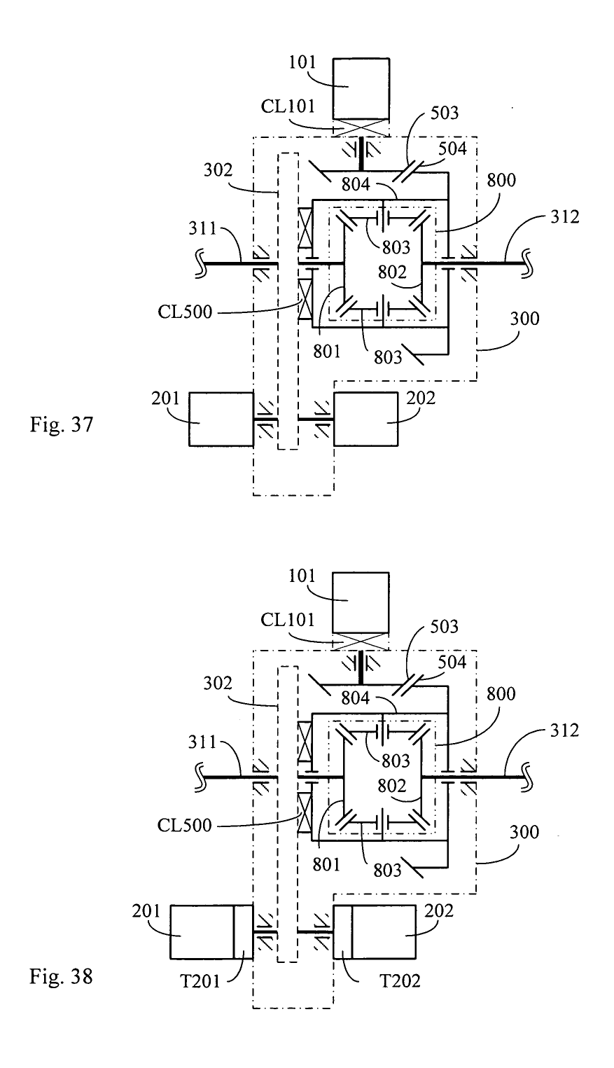

FIG. 37 is a structural schematic diagram showing the embodiment that the rotary power source driven by two electric machineries constitutes the second driving units (201) and (202) in the embodiment of FIG. 35, according to the present invention.

As shown in FIG. 37, two electric machineries further constitute the second driving units (201) and (202) in the embodiment of FIG. 35, and two or one of the electric machineries drive the input terminal of the second transmission (302).

FIG. 38 is a structural schematic diagram showing the embodiment that the rotary power source driven by two electric machineries constitutes the second driving units (201) and (202) in the embodiment of FIG. 36, according to the present invention.

As shown in FIG. 38, two electric machineries further constitute the second driving units (201) and (202) in the embodiment of FIG. 36, and two or one of the electric machineries respectively through the speed variable transmission (T201) and the speed variable transmission (T202) drive the input terminal of the second transmission (302).

For the dual gear train driving structure at input side of basin-type gear, the controllable clutch unit (CL5011) is further installed between the umbrella-type planetary gear power transmission rocker arm (804) and the driving wheel group of the first transmission, and the controllable clutch unit (CL5012) is further installed between the umbrella-type planetary gear power transmission rocker arm (804) and the driving wheel group of the second transmission (302), so as to control engaged or disengaged operation in various permutations and combinations between the controllable clutch unit (CL5011) and the controllable clutch unit (CL5012) on the basis of operational function;

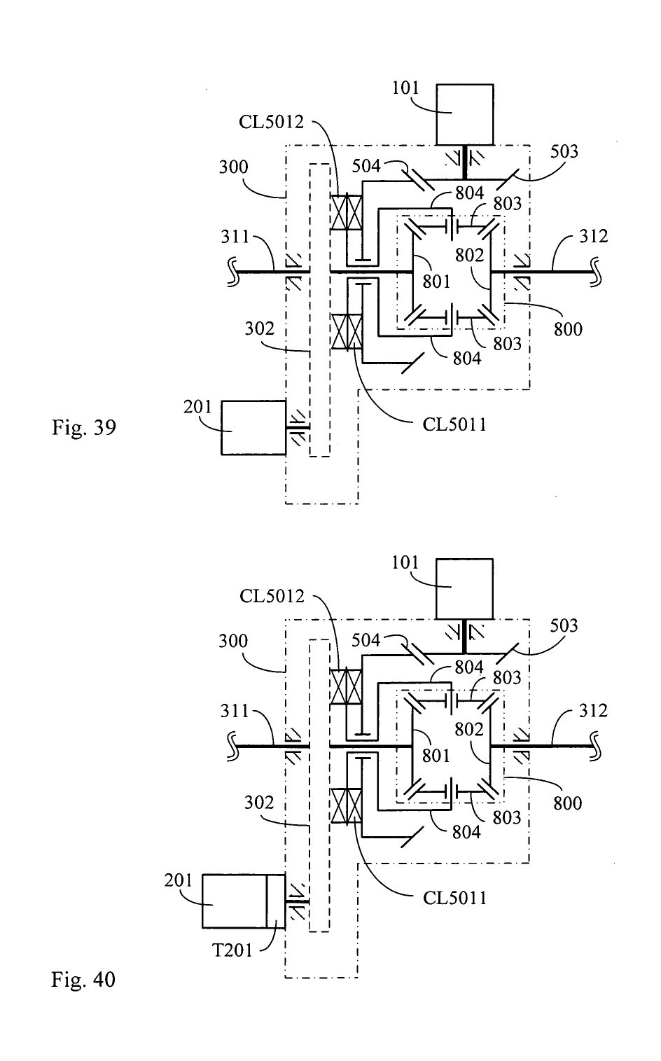

FIG. 39 is a structural schematic diagram showing the embodiment that the controllable clutch unit (CL5011) is installed between the umbrella-type planetary gear power transmission rocker arm (804) and the driving wheel group of the first transmission (301), and the controllable clutch unit (CL5012) is installed between the umbrella-type planetary gear power transmission rocker arm (804) and the driving wheel group of the second transmission (302), according to the present invention.

As shown in FIG. 39, except for the rotary power source driven by the internal combustion engine constituting the first driving unit (101), and the rotary power source driven by the electric machinery constituting the second driving unit (201), the main components including:

differential gear set assembly (300): equipped with the controllable clutch units (CL5011) and (CL5012), in which the controllable clutch unit (CL5011) is installed between the umbrella-type planetary gear power transmission rocker arm (804) and the driving wheel group of the first transmission, and the controllable clutch unit (CL5012) is installed between the umbrella-type planetary gear power transmission rocker arm (804) and the driving wheel group of the second transmission (302), so as to control engaged or disengaged operation in various permutations and combinations between the controllable clutch unit (CL5011) and the controllable clutch unit (CL5012) on the basis of operational function, including that the first transmission (301) is constituted by the first transmission input bevel gear (503) and the basin-type bevel gear of the first transmission (504), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804) through the controllable clutch unit (CL5011); and/or the rotary kinetic energy of the second driving unit (201) drives the umbrella-type planetary gear power transmission rocker arm (804) of the differential gear set (800) through the second transmission (302) and the controllable clutch unit (CL5012); and the differential gear set (800) is installed with the differential output shaft (311) and the differential output shaft (312) to coaxially output externally, and is equipped with the case and the bearing of differential gear set assembly;

controllable clutch units (CL5011), (CL5012): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the umbrella-type planetary gear power transmission rocker arm (804) and the first transmission (301) through the controllable clutch unit (CL5011), and/or transmits the rotary kinetic energy between the umbrella-type planetary gear power transmission rocker arm (804) and the second transmission (302) through the controllable clutch unit (CL5012); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

FIG. 40 is a structural schematic diagram showing the embodiment that the speed variable transmission (T201) is additionally installed between the output terminal of the second driving unit (201) and the input terminal of the second transmission (302) in FIG. 39, according to the present invention.

As shown in FIG. 40, the speed variable transmission (T201) is additionally installed between the output terminal of the second driving unit (201) and the input terminal of the second transmission (302) in the embodiment of FIG. 39 to change the speed ratio between the output terminal of the second driving unit (201) and the input terminal of the second transmission (302).

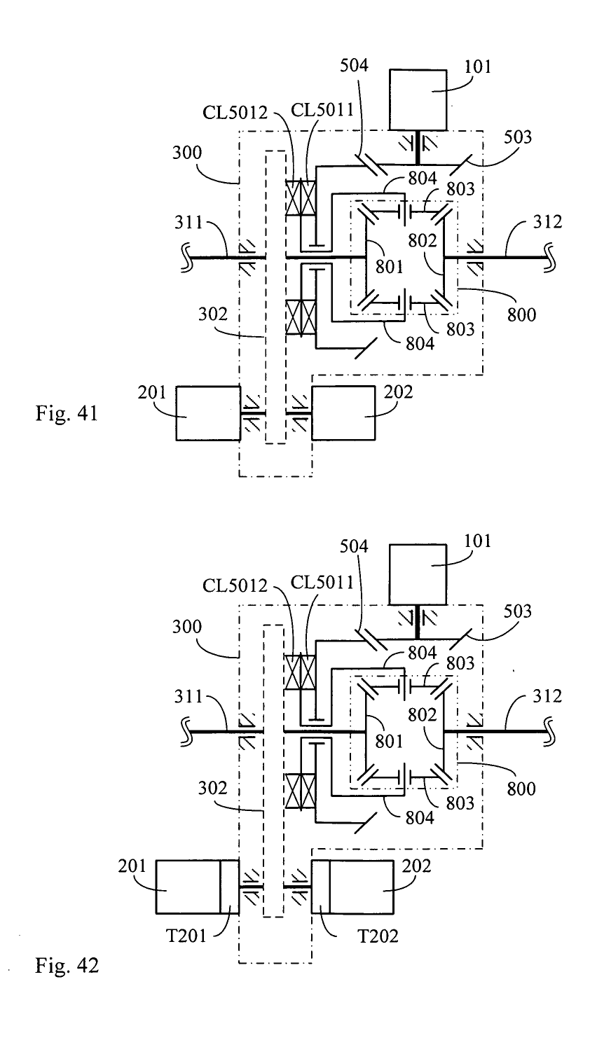

FIG. 41 is a structural schematic diagram showing the embodiment that the rotary power source driven by two electric machineries constitutes the second driving units (201) and (202) in FIG. 39, according to the present invention.

As shown in FIG. 41, two electric machineries further constitute the second driving units (201) and (202) in the embodiment of FIG. 39, and two or one of the electric machineries drive the input terminal of the second transmission (302).

FIG. 42 is a structural schematic diagram showing the embodiment that the rotary power source driven by two electric machineries constitutes the second driving units (201) and (202) in FIG. 40, according to the present invention.

As shown in FIG. 42, two electric machineries further constitute the second driving units (201) and (202) in the embodiment of FIG. 40, and two or one of the electric machineries respectively through the speed variable transmission (T201) and the speed variable transmission (T202) drive the input terminal of the second transmission (302).

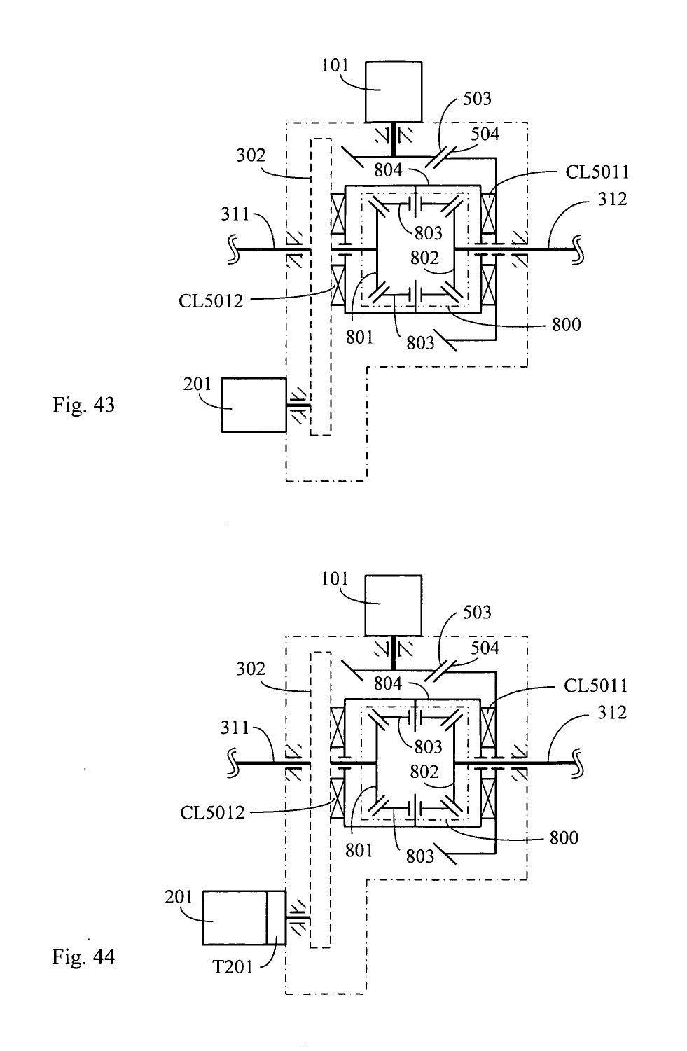

FIG. 43 is a structural schematic diagram showing the embodiment that the second driving unit (201) constituted by the single electric machinery drives the input terminal of the second transmission (302), and the umbrella-type planetary gear power transmission rocker arm (804) is installed at two sides of the differential gear set (800), in which the controllable clutch unit (CL5011) is installed between one side of the umbrella-type planetary gear power transmission rocker arm (804) and the basin-type bevel gear of the first transmission (504), while the controllable clutch unit (CL5012) is installed between the other side of the umbrella-type planetary gear power transmission rocker arm (804) and the second transmission (302), according to the present invention.

As shown in FIG. 43, except for the rotary power source driven by the internal combustion engine constituting the first driving unit (101), and the rotary power source driven by the electric machinery constituting the second driving unit (201), the main components including:

differential gear set assembly (300): equipped with the controllable clutch units (CL5011) and (CL5012), in which the umbrella-type planetary gear power transmission rocker arm (804) is installed at two sides of the differential gear set (800), in which the controllable clutch unit (CL5011) is installed between one side of the umbrella-type planetary gear power transmission rocker arm (804) and the basin-type bevel gear of the first transmission (504), while the controllable clutch unit (CL5012) is installed between the other side of the umbrella-type planetary gear power transmission rocker arm (804) and the driving wheel of the second transmission (302), so as to control engaged or disengaged operation in various permutations and combinations between the controllable clutch unit (CL5011) and the controllable clutch unit (CL5012) on the basis of operational function, including that the first transmission (301) is constituted by the first transmission input bevel gear (503) and the basin-type bevel gear of the first transmission (504), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804) through the controllable clutch unit (CL5011); and/or the rotary kinetic energy of the second driving unit (201) drives the umbrella-type planetary gear power transmission rocker arm (804) through the second transmission (302) and the controllable clutch unit (CL5012); and the differential gear set (800) is installed with the differential output shaft (311) and the differential output shaft (312) to coaxially output externally, and is equipped with the case and the bearing of differential gear set assembly;

controllable clutch units (CL5011), (CL5012): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side; and

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the umbrella-type planetary gear power transmission rocker arm (804) and the first transmission (301) through the controllable clutch unit (CL5011), and/or transmits the rotary kinetic energy between the umbrella-type planetary gear power transmission rocker arm (804) and the second transmission (302) through the controllable clutch unit (CL5012);

FIG. 44 is a structural schematic diagram showing the embodiment that single electric machinery constitutes the second driving unit (201), and the speed variable transmission (T201) is installed between the output terminal of the second driving unit (201) and the input terminal of the second transmission (302), according to the present invention.

As shown in FIG. 44, the speed variable transmission (T201) is installed between the output terminal of the second driving unit (201) and the input terminal of the second transmission (302) in the embodiment on FIG. 43 to change the speed ratio between the output terminal of the second driving unit (201) and the input terminal of the second transmission (302).

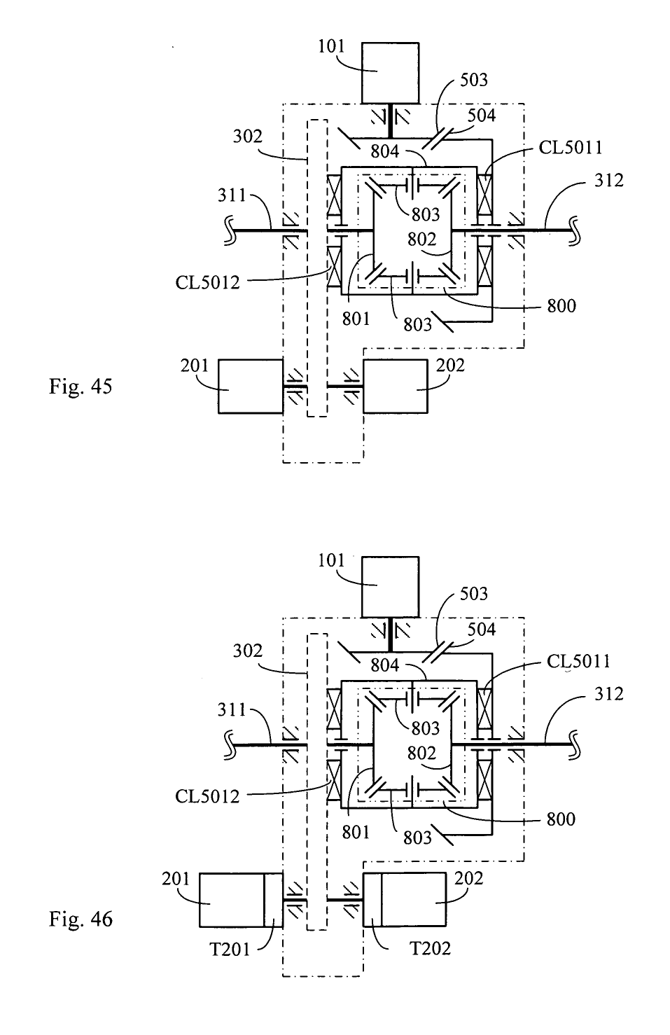

FIG. 45 is a structural schematic diagram showing the embodiment that two electric machineries are further installed for constituting the second driving units (201) and (202) in the embodiment of FIG. 43 to together drive the input terminal of the second transmission (302), according to the present invention.

As shown in FIG. 45, two electric machineries are further installed for constituting the second driving units (201) and (202) in the embodiment on FIG. 43, and two or one of the electric machineries drive the input terminal of the second transmission (302).

FIG. 46 is a structural schematic diagram showing the embodiment that the embodiment of FIG. 44 are further installed with two electric machineries for constituting the second driving units (201) and (202), and the speed variable transmission (T201) and the speed variable transmission (T202) are installed, according to the present invention.

As shown in FIG. 46, two electric machineries further constitute the second driving units (201) and (202) in the embodiment on FIG. 44, and two or one of the electric machineries respectively through the speed variable transmission (T201) and the speed variable transmission (T202) drive the input terminal of the second transmission (302);

For the dual gear train driving structure at input side of basin-type gear, the umbrella-type planetary gear power transmission rocker arm (804) of the differential gear set (800) further extends toward two sides, and the basin-type bevel gear of the first transmission (504) and the first transmission input bevel gear (503), and the basin-type bevel gear of the second transmission (5042) and the second transmission input bevel gear (507) are installed, the two sets are in separation, wherein the first transmission input bevel gear (503) is driven by the first driving unit (101), then is through the basin-type bevel gear of the first transmission (504) to drive one side of the umbrella-type planetary gear power transmission rocker arm (804), while the second transmission input bevel gear (507) is driven by the second driving unit (201), then is through the basin-type bevel gear of the second transmission (5042) to drive the other side of the umbrella-type planetary gear power transmission rocker arm (804), whereas the umbrella-type planetary gear power transmission rocker arm (804) transmits the rotary kinetic energy to the differential gear set (800);

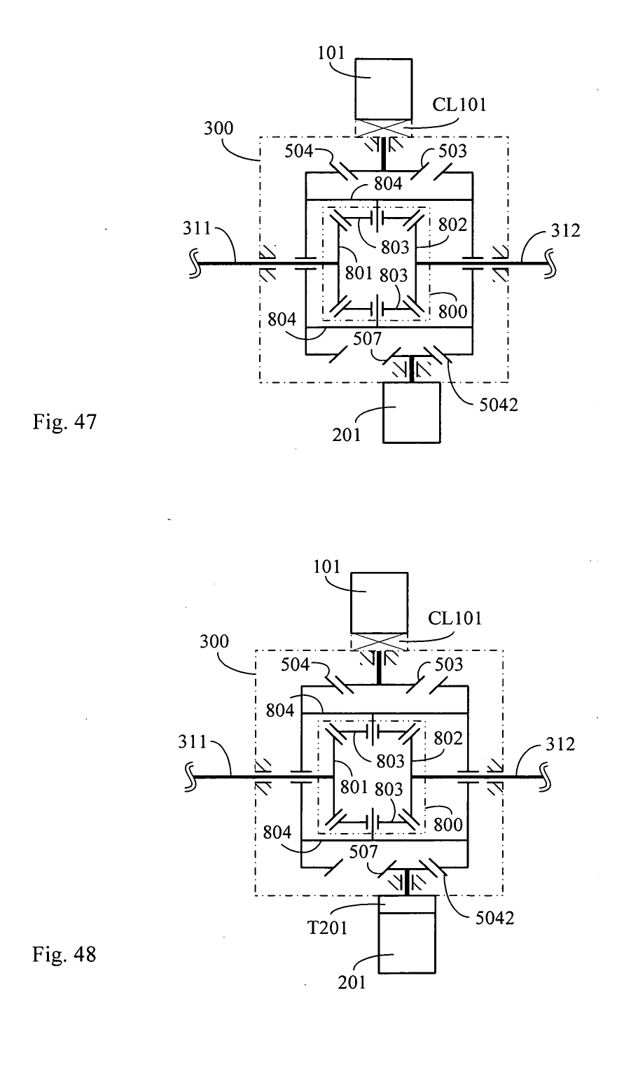

FIG. 47 is a structural schematic diagram showing the embodiment that single electric machinery constitutes the second driving unit (201) for driving the second transmission input bevel gear (507) at the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, according to the present invention.

As shown in FIG. 47, except for the second transmission input bevel gear (507) at the input terminal of the second transmission (302), which is driven by the second driving unit (201) constituted by the single electric machinery, the main components including:

differential gear set assembly (300): the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, wherein the first transmission input bevel gear (503) is directly or through the controllable clutch unit (CL101) driven by the first driving unit (101), then is through the basin-type bevel gear of the first transmission (504) to drive one side of the umbrella-type planetary gear power transmission rocker arm (804), while the second transmission input bevel gear (507) is driven by the second driving unit (201), then is through the basin-type bevel gear of the second transmission (5042) to drive the other side of the umbrella-type planetary gear power transmission rocker arm (804);

controllable clutch unit (CL101): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

FIG. 48 is a structural schematic diagram showing the embodiment that single electric machinery constitutes the second driving unit (201), and the speed variable transmission (T201) is installed between the output terminal of the second driving unit (201) and the second transmission input bevel gear (507) at the input terminal of the second transmission (302) in FIG. 47.

As shown in FIG. 48, the single electric machinery constitutes the second driving unit (201), and the speed variable transmission (T201) is installed between the second driving unit (201) and the second transmission (302) to change the speed ratio between the output terminal of the second driving unit (201) and the second transmission input bevel gear (507).

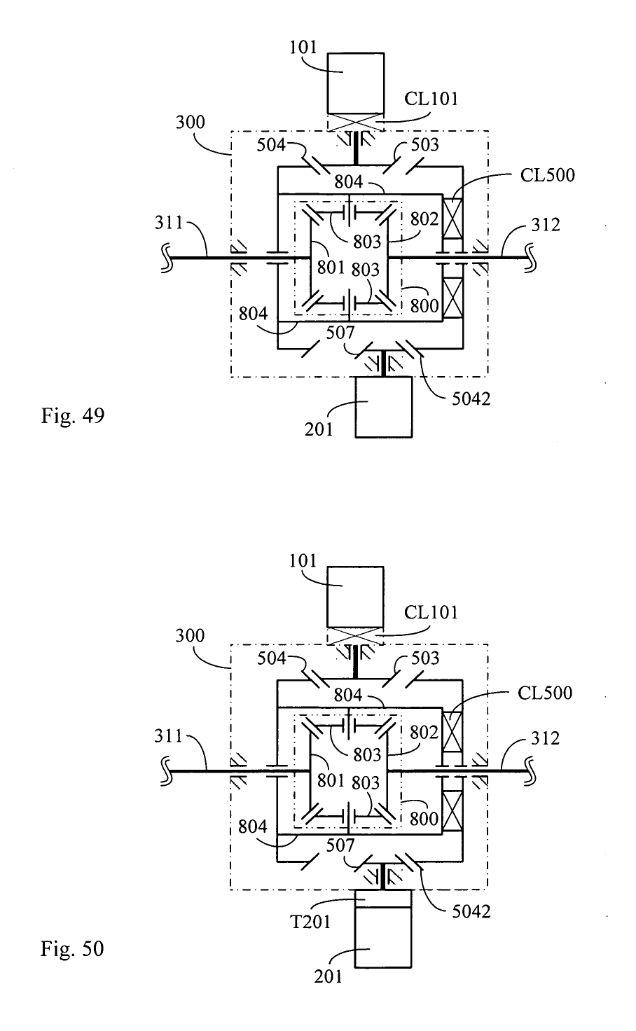

FIG. 49 is a structural schematic diagram showing the embodiment that the single electric machinery constitutes the second driving unit (201) for driving the second transmission input bevel gear (507) at the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, the two sets are in separation, and the controllable clutch unit (CL500) is installed between the basin-type bevel gear of the second transmission (5042) and the umbrella-type planetary gear power transmission rocker arm (804), according to the present invention.

As shown in FIG. 49, except for the second driving unit (201) constituted by single electric machinery for driving the input terminal of the second transmission (302), the main components including:

differential gear set assembly (300): it is arranged that the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, and the controllable clutch unit (CL500) is installed between the basin-type bevel gear of the second transmission (5042) and the umbrella-type planetary gear power transmission rocker arm (804), wherein the first transmission input bevel gear (503) is driven by the first driving unit (101), then is through the basin-type bevel gear of the first transmission (504) to drive one side of the umbrella-type planetary gear power transmission rocker arm (804), while the second transmission input bevel gear (507) is driven by the second driving unit (201), then is through the basin-type bevel gear of the second transmission (5042) to drive the controllable clutch unit (CL500), and to further drive the other side of the umbrella-type planetary gear power transmission rocker arm (804);

controllable clutch units (CL101), (CL500): constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) through the umbrella-type planetary gear power transmission rocker arm (804), and/or transmits the rotary kinetic energy between the differential gear set (800) and the second transmission (302) through the controllable clutch unit (CL500); and

the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

FIG. 50 is a structural schematic diagram showing the embodiment that the single electric machinery constitutes the second driving unit (201), and the speed variable transmission (T201) is installed between the output terminal of the second driving unit (201) and the second transmission input bevel gear (507) at the input terminal of the second transmission (302) in FIG. 49.

As shown in FIG. 50, the single electric machinery constitutes the second driving unit (201), and the speed variable transmission (T201) is installed between the output terminal of the second driving unit (201) and the second transmission input bevel gear (507) at the input terminal of the second transmission (302) to change the speed ratio between the output terminal of the second driving unit (201) and the second transmission input bevel gear (507).

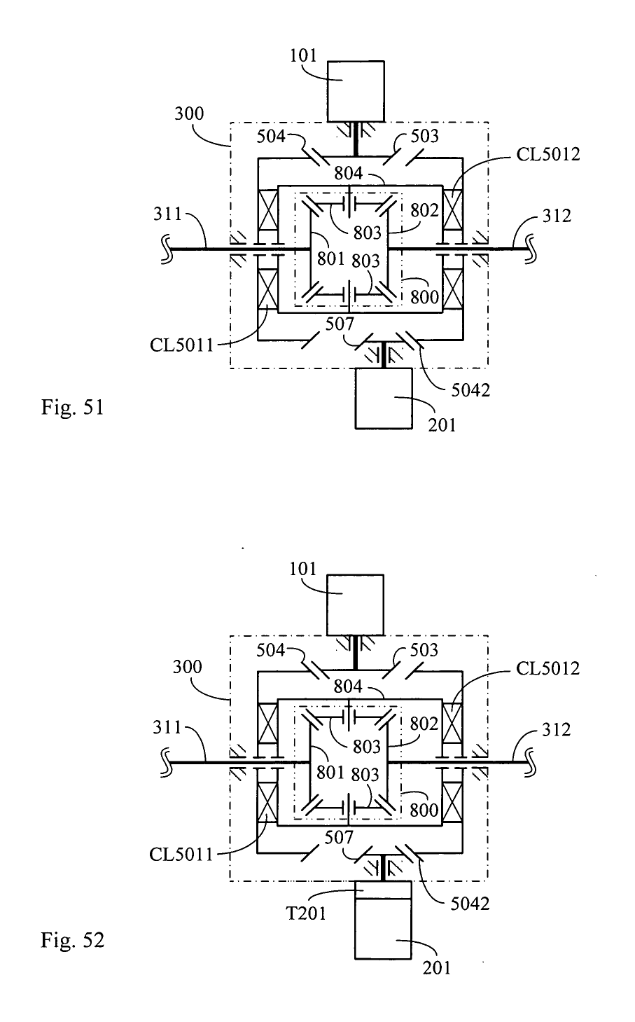

FIG. 51 is a structural schematic diagram showing the embodiment that the single electric machinery constitutes the second driving unit (201) for driving the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, the two sets are in separation, the controllable clutch unit (CL5011) is installed between the basin-type bevel gear of the first transmission (504) and the umbrella-type planetary gear power transmission rocker arm (804), and the controllable clutch unit (CL5012) is installed between the basin-type bevel gear of the second transmission (5042) and the umbrella-type planetary gear power transmission rocker arm (804), according to the present invention.

As shown in FIG. 51, except for the second driving unit (201) constituted by single electric machinery for driving the input terminal of the second transmission (302), the main components including:

differential gear set assembly (300): it is arranged that the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, the controllable clutch unit (CL5011) is installed between the basin-type bevel gear of the first transmission (504) and the umbrella-type planetary gear power transmission rocker arm (804), while the controllable clutch unit (CL5012) is installed between the basin-type bevel gear of the second transmission (5042) and the umbrella-type planetary gear power transmission rocker arm (804), wherein the first transmission input bevel gear (503) is driven by the first driving unit (101), then is through the basin-type bevel gear of the first transmission (504) to drive the controllable clutch unit (CL5011), and further drives one side of the umbrella-type planetary gear power transmission rocker arm (804), whereas, the second transmission input bevel gear (507) is driven by the second driving unit (201), then is through the basin-type bevel gear of the second transmission (5042) to drive the controllable clutch unit (CL5012), and to further drive the other side of the umbrella-type planetary gear power transmission rocker arm (804);

controllable clutch units (CL5011), (CL5012): constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;

differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the umbrella-type planetary gear power transmission rocker arm (804) and the first transmission (301) through the controllable clutch unit (CL5011), and/or transmits the rotary kinetic energy between the umbrella-type planetary gear power transmission rocker arm (804) and the second transmission (302) through the controllable clutch unit (CL5012).

FIG. 52 is a structural schematic diagram showing the embodiment that the single electric machinery constitutes the second driving unit (201), and the speed variable transmission (T201) is installed between the output terminal of the second driving unit (201) and the second transmission input bevel gear (507) at the input terminal of the second transmission (302) in the embodiment of FIG. 51.

As shown in FIG. 52, the single electric machinery constitutes the second driving unit (201), and the speed variable transmission (T201) is installed between the output terminal of the second driving unit (201) and the second transmission input bevel gear (507) at the input terminal of the second transmission (302) to change the speed ratio between the output terminal of the second driving unit (201) and the second transmission input bevel gear (507).

1. A dual gear train driving structure at input side of basin-type gear, wherein the differential gear set input rocker arm driven by the basin-type bevel gear in the differential gear set assembly is made to be driven by two sets of transmissions, in which the first transmission transmits the rotary kinetic energy between the differential gear set input rocker arm and the engine, the second transmission transmits the rotary kinetic energy between the differential gear set input rocker arm and the second driving unit, and one or both of the transmissions drives the differential gear set input rocker arm, the main components including:
differential gear set assembly (300): constituted by gear, or friction wheel, or pulley, or sprocket, or CVT, in which the first transmission (301) is used to directly or through the controllable clutch unit (CL101) and/or transmission transmit the rotary kinetic energy between the first driving unit (101) and the umbrella-type planetary gear power transmission rocker arm (804) of the differential gear set (800), the second transmission (302) is used to transmit the rotary kinetic energy between the second driving unit (201) and the umbrella-type planetary gear power transmission rocker arm (804) of the differential gear set (800), and the differential gear set (800) is installed with the differential output shaft (311) and the differential output shaft (312) to coaxially output externally, and the case and the bearing of the differential gear set assembly are included;
controllable clutch unit (CL101): controllable clutch unit (CL101): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to umbrella-type differential gear constituted by umbrella-type gear or umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804);
first transmission (301): related to a transmission constituted by gear, or friction wheel, or pulley and transmission belt, or CVT wheel and transmission belt, or sprocket and transmission chain, including the structure of parallel input shaft and output shaft transmission, or non-parallel angle axis transmission, in which the input terminal of the first transmission is driven by the first driving unit (101), and the driving wheel of the first transmission drives the umbrella-type planetary gear power transmission rocker arm (804) of the differential gear set (800);
second transmission (302): related to a transmission constituted by gear, or friction wheel, or pulley and transmission belt, or CVT wheel and transmission belt, or sprocket and transmission chain, including the structure of parallel input shaft and output shaft transmission, or non-parallel angle axis transmission, in which the input terminal of the second transmission is driven by the second driving unit (202), and the driving wheel of the second transmission drives the umbrella-type planetary gear power transmission rocker arm (804) of the differential gear set (800); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

2. The dual gear train driving structure at input side of basin-type gear as claimed in claim 1, the main components including:
differential gear set assembly (300): including the first transmission (301), constituted by the first transmission input bevel gear (503) and the basin-type bevel gear of the first transmission (504), which is used to directly or through the controllable clutch unit (CL101) and/or the transmission transmit the rotary kinetic energy between the first driving unit (101) and the umbrella-type planetary gear power transmission rocker arm (804) of the differential gear set (800), and including the second transmission (302), constituted by the second transmission input gear (505) and the transmission gear of the second transmission (506), which is used to transmit the rotary kinetic energy between the second driving unit (201) and the umbrella-type planetary gear power transmission rocker arm (804) of the differential gear set (800), and the differential gear set (800) is installed with the differential output shaft (311) and the differential output shaft (312) to coaxially output externally, and the case and the bearing of the differential gear set assembly are included;
controllable clutch unit (CL101): constituted by clutch unit or structure capable of implementing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to umbrella-type differential gear constituted by umbrella-type gear or umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

3. The dual gear train driving structure at input side of basin-type gear as claimed in claim 2, in which the controllable clutch unit (CL201) is further installed between the output terminal of the rotary part of the electric machinery constituting single set of the second driving unit (201) and the second transmission input gear (505), to control the engaged or disengaged operation between the output terminal of the rotary part of the electric machinery and the second transmission input gear (505).

4. The dual gear train driving structure at input side of basin-type gear as claimed in claim 2, in which the speed variable transmission (T201) is further installed between the output terminal of the rotary part of the electric machinery constituting single set of the second driving unit (201) and the second transmission input gear (505) to change the speed ratio between the rotary part of the electric machinery and the second transmission input gear (505).

5. The dual gear train driving structure at input side of basin-type gear as claimed in claim 2, in which the output terminal of the rotary part of the electric machinery constituting single set of the second driving unit (201) further through the clutch unit (CL201) and then through the speed variable transmission (T201) connects to the second transmission input gear (505), so as by means of the controllable clutch unit (CL201) to control the engaged or disengaged operation between the output terminal of the rotary part of the electric machinery and the speed variable transmission (T201), and by means of the second driving unit (201) to change the speed ratio between the output terminal of the rotary part of the electric machinery and the second transmission input gear (505) through.

6. The dual gear train driving structure at input side of basin-type gear as claimed in claim 2, in which two sets of the output terminals of the rotary part of the electric machinery constituting the second driving unit (201) is further through the speed variable transmission (T201) and then through the controllable clutch unit (CL201) connected to the second transmission input gear (505), and by means of the speed variable transmission (T201) to change the speed ratio between the output terminal of the rotary part of the electric machinery and the input terminal of the controllable clutch unit (CL201), and by means of the controllable clutch unit (CL201) to control the engaged or disengaged operation between the output terminal of the speed variable transmission (T201) and the second transmission input gear (505).

7. The dual gear train driving structure at input side of basin-type gear as claimed in claim 2, in which two electric machineries are further installed, thus the rotary power sources driven by the two electric machineries constitute the second driving units (201) and (202), and two or one of the electric machineries drive the second transmission input gear (505).

8. The dual gear train driving structure at input side of basin-type gear as claimed in claim 3, in which two electric machineries are further installed, thus the rotary power sources driven by the two electric machineries constitute the second driving units (201) and (202), and the two controllable clutch units (CL201) and (CL202) are individually installed between each of the output terminals of the rotary parts of the two electric machineries and the second transmission input gear (505), thereby by means of two or one of the electric machineries to drive the second transmission input gear (505).

9. The dual gear train driving structure at input side of basin-type gear as claimed in claim 4, in which two electric machineries are further installed, thus the rotary power sources driven by the two electric machineries constitute the second driving units (201) and (202), and the two speed variable transmissions (T201) and (T202) are individually installed between each of the output terminals of the rotary parts of the two electric machineries and the second transmission input gear (505), thereby by means of two or one of the electric machineries to drive the second transmission input gear (505).

10. The dual gear train driving structure at input side of basin-type gear as claimed in claim 5, in which two electric machineries are further installed, thus the rotary power sources driven by the two electric machineries constitute the second driving units (201) and (202), and the output terminals of the rotary parts of the two electric machineries are individually through the controllable clutch units (CL201) and (CL202) and then through the speed variable transmissions (T201) and (T202) connected to the second transmission input gear (505), thereby by means of two or one of the electric machineries to drive the second transmission input gear (505).

11. The dual gear train driving structure at input side of basin-type gear as claimed in claim 6, in which two electric machineries are further installed, thus the rotary power sources driven by the two electric machineries constitute the second driving units (201) and (202), and the output terminals of the rotary parts of the two electric machineries are individually through the speed variable transmissions (T201) and (T202) and then through the controllable clutch units (CL201) and (CL202) connected to the second transmission input gear (505), thereby by means of two or one of the electric machineries to drive the second transmission input gear (505).

12. The dual gear train driving structure at input side of basin-type gear as claimed in claim 1, including that the basin-type bevel gear of the first transmission (504) and the basin-type bevel gear of the second transmission (5041) are made as an integral structure, or are through welding or melting to become an integral structure to constitute the integrated dual basin-type bevel gear set with same outer diameter (400), in which the basin-type bevel gear of the first transmission (504) and the basin-type bevel gear of the second transmission (5041) have same outer diameter while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5041) is used for along with the corresponding second transmission input bevel gear constituting the second transmission (302).

13. The dual gear train driving structure at input side of basin-type gear as claimed in claim 1, including that the basin-type bevel gear of the first transmission (504) and the basin-type bevel gear of the second transmission (5042) are made as an integral structure, or are through welding or melting to become an integral structure to constitute the integrated dual basin-type bevel gear set with different outer diameters (410), in which the basin-type bevel gear of the first transmission (504) and the basin-type bevel gear of the second transmission (5042) have different outer diameters, including the outer diameter of the basin-type bevel gear of the first transmission (504) is larger or less than that of the basin-type bevel gear of the second transmission (5042), while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5042) is used for along with the corresponding second transmission input bevel gear constituting the second transmission (302).

14. The dual gear train driving structure at input side of basin-type gear as claimed in claim 1, including that the basin-type bevel gear of the first transmission (504) and the transmission gear of the second transmission (506) are made as an integral structure, or are through welding or melting to become an integral structure to constitute the integrated transmission gear and bevel gear set (420), in which the basin-type bevel gear of the first transmission (504) is used for along with the first transmission input bevel gear (503) constituting the first transmission (301), and the transmission gear of the second transmission (506) is used for along with the relative second transmission input gear (505) constituting the second transmission (302).

15. The dual gear train driving structure at input side of basin-type gear as claimed in claim 1, including that the basin-type bevel gear of the first transmission (504) and the transmission sprocket of the second transmission (5061) are made as an integral structure, or are through welding or melting to become an integral structure to constitute the integrated transmission sprocket and basin-type bevel gear set (430), in which the basin-type bevel gear of the first transmission (504) is used for along with the first transmission input bevel gear (503) constituting the first transmission (301), and the transmission sprocket of the second transmission (5061) is used for along with the corresponding second transmission input sprocket and transmission chain constituting the second transmission (302).

16. The dual gear train driving structure at input side of basin-type gear as claimed in claim 1, including that the basin-type bevel gear of the first transmission (504) and the transmission pulley of the second transmission (5062) are made as an integral structure, or are through welding or melting to become an integral structure to constitute the integrated transmission pulley and basin-type bevel gear set (440), in which the basin-type bevel gear of the first transmission (504) is used for along with the first transmission input bevel gear (503) constituting the first transmission (301), and the transmission pulley of the second transmission (5062) is used for along with the corresponding second transmission input pulley and transmission belt constituting the second transmission (302).

17. The dual gear train driving structure at input side of basin-type gear as claimed in claim 1, including that the basin-type bevel gear of the first transmission (504) and the transmission CVT wheel of the second transmission (5063) are made as an integral structure, or are through welding or melting to become an integral structure to constitute the integrated transmission CVT wheel and basin-type bevel gear set (450), in which the basin-type bevel gear of the first transmission (504) is used for along with the first transmission input bevel gear (503) constituting the first transmission (301), and the transmission CVT wheel of the second transmission (5063) is used for along with the corresponding second transmission input CVT wheel and CVT wheel transmission belt constituting the second transmission (302).

18. The dual gear train driving structure at input side of basin-type gear as claimed in claim 1, including that the combined dual basin-type bevel gear set with same outer diameter (500) is constituted by the combination of the basin-type bevel gear of the first transmission (504) and the basin-type bevel gear of the second transmission (5041), including the combined structure through screws locking, or riveting, or fastening, or lamination, or embedding, in which the basin-type bevel gear of the first transmission (504) and the basin-type bevel gear of the second transmission (5041) in the combined structure have the same outer diameter while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5041) is used for along with the corresponding second transmission input bevel gear constituting the second transmission (302).

19. The dual gear train driving structure at input side of basin-type gear as claimed in claim 1, including that the combined dual basin-type bevel gear set with different outer diameter (510) is constituted by the combination of the basin-type bevel gear of the first transmission (504) and the basin-type bevel gear of the second transmission (5042), including the combined structure through screws locking, or riveting, or fastening, or lamination, or embedding, in which the basin-type bevel gear of the first transmission (504) and the basin-type bevel gear of the second transmission (5042) in the combined structure have different outer diameters, including the outer diameter of the basin-type bevel gear of the first transmission (504) is larger or less than that of the basin-type bevel gear of the second transmission (5042) while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5042) is used for along with the corresponding second transmission input bevel gear constituting the second transmission (302).

20. The dual gear train driving structure at input side of basin-type gear as claimed in claim 1, including that the combined transmission gear and basin-type bevel gear set (520) is constituted by the combination of the basin-type bevel gear of the first transmission (504) and the transmission gear of the second transmission (506), including the combined structure through screws locking, or riveting, or fastening, or lamination, or embedding, in which the basin-type bevel gear of the first transmission (504) is used for along with the first transmission input bevel gear (503) constituting the first transmission (301), and the transmission gear of the second transmission (506) is used for along with the corresponding second transmission input gear (505) constituting the second transmission (302).

21. The dual gear train driving structure at input side of basin-type gear as claimed in claim 1, including that the combined transmission sprocket and basin-type bevel gear set (530) is constituted by the combination of the basin-type bevel gear of the first transmission (504) and the transmission sprocket of the second transmission (5061), including the combined structure through screws locking, or riveting, or fastening, or lamination, or embedding, in which the basin-type bevel gear of the first transmission (504) is used for along with the first transmission input bevel gear (503) constituting the first transmission (301), and the transmission sprocket of the second transmission (5061) is used for along with the corresponding second transmission input sprocket and transmission chain constituting the second transmission (302).

22. The dual gear train driving structure at input side of basin-type gear as claimed in claim 1, including that the combined transmission pulley and basin-type bevel gear set (540) is constituted by the combination of the basin-type bevel gear of the first transmission (504) and the transmission pulley of the second transmission (5062), including the combined structure through screws locking, or riveting, or fastening, or lamination, or embedding, in which the basin-type bevel gear of the first transmission (504) is used for along with the first transmission input bevel gear (503) constituting the first transmission (301), and the transmission pulley of the second transmission (5062) is used for along with the corresponding second transmission input pulley and transmission belt constituting the second transmission (302).

23. The dual gear train driving structure at input side of basin-type gear as claimed in claim 1, including that the combined transmission CVT wheel and basin-type bevel gear set (550) is constituted by the combination of the basin-type bevel gear of the first transmission (504) and the transmission CVT wheel of the second transmission (5063), including the combined structure through screws locking, or riveting, or fastening, or lamination, or embedding, in which the basin-type bevel gear of the first transmission (504) is used for along with the first transmission input bevel gear (503) constituting the first transmission (301), and the transmission CVT wheel of the second transmission (5063) is used for along with the corresponding second transmission input CVT wheel and CVT wheel transmission belt constituting the second transmission (302).

24. The dual gear train driving structure at input side of basin-type gear as claimed in claim 1, including that the controllable clutch unit (CL500) is installed between the basin-type bevel gear of the first transmission (504) and the basin-type bevel gear of the second transmission (5041) to constitute the dual basin-type bevel gear set (600) with same outer diameter and clutch unit (CL500), in which the basin-type bevel gear of the first transmission (504) and the basin-type bevel gear of the second transmission (5041) have same outer diameter while the tooth type, and/or the gear modulus, and/or the tooth number can be the same or different, and the basin-type bevel gear of the first transmission (504) is used for along with the first transmission input bevel gear (503) constituting the first transmission (301), and the basin-type bevel gear of the second transmission (5041) is used for along with the corresponding second transmission input bevel gear constituting the second transmission (302); moreover, the engagement or disengagement between the basin-type bevel gear of the second transmission (5041) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

25. The dual gear train driving structure at input side of basin-type gear as claimed in claim 1, including that the controllable clutch unit (CL500) is installed between the basin-type bevel gear of the first transmission (504) and the basin-type bevel gear of the second transmission (5042) to constitute the dual basin-type bevel gear set with different outer diameters (610) and clutch unit (CL500), in which the basin-type bevel gear of the first transmission (504) and the basin-type bevel gear of the second transmission (5042) have different outer diameters, including the outer diameter of the basin-type bevel gear of the first transmission (504) is larger or less than that of the basin-type bevel gear of the second transmission (5042) while the tooth type, and/or the gear modulus, and/or the tooth number can be the same or different; the basin-type bevel gear of the first transmission (504) is used for along with the first transmission input bevel gear (503) constituting the first transmission (301), and the basin-type bevel gear of the second transmission (5042) is used for along with the corresponding second transmission input bevel gear constituting the second transmission (302); moreover, the engagement or disengagement between the basin-type bevel gear of the second transmission (5042) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

26. The dual gear train driving structure at input side of basin-type gear as claimed in claim 1, including that the controllable clutch unit (CL500) is installed between the basin-type bevel gear of the first transmission (504) and the transmission gear of the second transmission (506) to constitute the transmission gear and basin-type bevel gear set (620) with the clutch unit (CL500), in which the basin-type bevel gear of the first transmission (504) is used for along with the first transmission input bevel gear (503) constituting the first transmission (301), and the transmission gear of the second transmission (506) is used for along with the relative second transmission input gear (505) constituting the second transmission (302); the engagement or disengagement between the transmission gear of the second transmission (506) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

27. The dual gear train driving structure at input side of basin-type gear as claimed in claim 1, including that the controllable clutch unit (CL500) is installed between the basin-type bevel gear of the first transmission (504) and the transmission sprocket of the second transmission (5061) to constitute the transmission sprocket and basin-type bevel gear set (630) with the clutch unit (CL500), in which the basin-type bevel gear of the first transmission (504) is used for along with the first transmission input bevel gear (503) constituting the first transmission (301), and the transmission sprocket of the second transmission (5061) is used for along with the corresponding second transmission input sprocket and transmission chain constituting the second transmission (302); the engagement or disengagement between the transmission sprocket of the second transmission (5061) and the basin-type bevel gear of the first transmission (504) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

28. The dual gear train driving structure at input side of basin-type gear as claimed in claim 1, including that the controllable clutch unit (CL500) is installed between the basin-type bevel gear of the first transmission (504) and the transmission pulley of the second transmission (5062) to constitute the transmission pulley and basin-type bevel gear set (640) with the clutch unit (CL500), in which the basin-type bevel gear of the first transmission (504) is used for along with the first transmission input bevel gear (503) constituting the first transmission (301), and the transmission gear of the second transmission (506) is used for along with the corresponding second transmission input pulley and transmission belt constituting the second transmission (302); the engagement or disengagement between the transmission pulley of the second transmission (5062) and the basin-type bevel gear of the first transmission (504) is controlled by the controllable clutch unit (CL500); and the controllable clutch unit (CL500) constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

29. The dual gear train driving structure at input side of basin-type gear as claimed in claim 1, including that the controllable clutch unit (CL500) is installed between the basin-type bevel gear of the first transmission (504) and the transmission CVT wheel of the second transmission (5063) to constitute the transmission CVT wheel and basin-type bevel gear set (650) with the clutch unit (CL500), in which the basin-type bevel gear of the first transmission (504) is used for along with the first transmission input bevel gear (503) constituting the first transmission (301), and the transmission CVT wheel of the second transmission (5063) is used for along with the relative second transmission input CVT wheel and CVT wheel transmission belt constituting the second transmission (302); the engagement or disengagement between the transmission CVT wheel of the second transmission (5063) and the transmission gear of the second transmission (506) is controlled by the controllable clutch unit (CL500); and the controllable clutch unit (CL500) is constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side.

30. The dual gear train driving structure at input side of basin-type gear as claimed in claim 1, including that the output terminal of the rotary part of electric machinery constituting the single set of the second driving unit (201) couples with the basin-type bevel gear of the first transmission (504) through the second transmission (302) and the controllable clutch unit (CL500), and then connects with the umbrella-type planetary gear power transmission rocker arm (804), the main components including:
differential gear set assembly (300): the controllable clutch unit (CL500) is installed between the driving wheel group of the first transmission and the driving wheel group of the second transmission for controlling the engaged or disengaged operation;
in which the first transmission input bevel gear (503) and the basin-type bevel gear of the first transmission (504) constitutes the first transmission (301), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804); and/or the rotary kinetic energy of the second driving unit (201) drives the umbrella-type planetary gear power transmission rocker arm (804) of the differential gear set (800) through the second transmission (302) and the controllable clutch unit (CL500); and the differential gear set (800) is installed with the differential output shaft (311) and the differential output shaft (312) to coaxially output externally, and the case and the bearing of differential gear set assembly are included;
controllable clutch units (CL101), (CL500): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

31. The dual gear train driving structure at input side of basin-type gear as claimed in claim 30, including that the speed variable transmission (T201) is installed between the output terminal of the rotary part in the second driving unit (201) and the input terminal of the second transmission (302), and the second transmission (302) and the controllable clutch unit (CL500) couple with the basin-type bevel gear of the first transmission (504), and then connect to the umbrella-type planetary gear power transmission rocker arm (804) to change the speed ratio between the output terminal of the second driving unit (201) and the input terminal of the second transmission (302).

32. The dual gear train driving structure at input side of basin-type gear as claimed in claim 30, including that two electric machineries are further installed to constitute the second driving units (201) and (202) to together drive the input terminal of the second transmission (302), and by means of two or one of the electric machineries to drive the input terminal of the second transmission (302).

33. The dual gear train driving structure at input side of basin-type gear as claimed in claim 31, in which two electric machineries further constitute the second driving units (201) and (202), and two or one of the electric machineries respectively through the speed variable transmission (T201) and the speed variable transmission (T202) drive the input terminal of the second transmission (302).

34. The dual gear train driving structure at input side of basin-type gear as claimed in claim 1, in which the umbrella-type planetary gear power transmission rocker arm (804) is further installed at both sides of the differential gear set (800), in which one side of the umbrella-type planetary gear power transmission rocker arm (804) combines with the basin-type bevel gear of the first transmission (504), and the other side couples with the second transmission (302) through the controllable clutch unit (CL500), so as to control the engaged transmission or disengagement between the second transmission (302) and the differential gear set (800), the main components including:
differential gear set assembly (300): the controllable clutch unit (CL500) is installed between the driving wheel group of the second transmission (302) and the umbrella-type planetary gear power transmission rocker arm (804) for controlling the engaged or disengaged operation; in which the first transmission input bevel gear (503) and the basin-type bevel gear of the first transmission (504) constitutes the first transmission (301), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804); and/or the rotary kinetic energy of the second driving unit (201) drives the umbrella-type planetary gear power transmission rocker arm (804) of the differential gear set (800) through the second transmission (302) and the controllable clutch unit (CL500); and the differential gear set (800) is installed with the differential output shaft (311) and the differential output shaft (312) to coaxially output externally, and is equipped with the the case and the bearing of differential gear set assembly;
controllable clutch units (CL101), (CL500): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) through the umbrella-type planetary gear power transmission rocker arm (804), and/or transmits the rotary kinetic energy between the second transmission (302) and the umbrella-type planetary gear power transmission rocker arm (804) through the controllable clutch unit (CL500); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

35. The dual gear train driving structure at input side of basin-type gear as claimed in claim 34, in which the speed variable transmission (T201) is installed between the output terminal of the rotary part of electric machinery in the second driving unit (201) and the input terminal of the second transmission (302) to change the speed ratio between the output terminal of the second driving unit (201) and the input terminal of the second transmission (302).

36. The dual gear train driving structure at input side of basin-type gear as claimed in claim 34, in which two electric machineries further constitute the second driving units (201) and (202), and two or one of the electric machineries drive the input terminal of the second transmission (302).

37. The dual gear train driving structure at input side of basin-type gear as claimed in claim 35, in which two electric machineries further constitute the second driving units (201) and (202) and two or one of the electric machineries respectively through the speed variable transmission (T201) and the speed variable transmission (T202) drive the input terminal of the second transmission (302).

38. The dual gear train driving structure at input side of basin-type gear as claimed in claim 1, in which the controllable clutch unit (CL5011) is further installed between the umbrella-type planetary gear power transmission rocker arm (804) and the driving wheel group of the first transmission, and the controllable clutch unit (CL5012) is further installed between the umbrella-type planetary gear power transmission rocker arm (804) and the driving wheel group of the second transmission (302), so as to control engaged or disengaged operation in various permutations and combinations between the controllable clutch unit (CL5011) and the controllable clutch unit (CL5012) on the basis of operational function, the main components including:
differential gear set assembly (300): equipped with the controllable clutch units (CL5011) and (CL5012), in which the controllable clutch unit (CL5011) is installed between the umbrella-type planetary gear power transmission rocker arm (804) and the driving wheel group of the first transmission, and the controllable clutch unit (CL5012) is installed between the umbrella-type planetary gear power transmission rocker arm (804) and the driving wheel group of the second transmission (302), so as to control engaged or disengaged operation in various permutations and combinations between the controllable clutch unit (CL5011) and the controllable clutch unit (CL5012) on the basis of operational function, including that the first transmission (301) is constituted by the first transmission input bevel gear (503) and the basin-type bevel gear of the first transmission (504), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804) through the controllable clutch unit (CL5011); and/or the rotary kinetic energy of the second driving unit (201) drives the umbrella-type planetary gear power transmission rocker arm (804) of the differential gear set (800) through the second transmission (302) and the controllable clutch unit (CL5012); and the differential gear set (800) is installed with the differential output shaft (311) and the differential output shaft (312) to coaxially output externally, and is equipped with the case and the bearing of differential gear set assembly;
controllable clutch units (CL5011), (CL5012): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the umbrella-type planetary gear power transmission rocker arm (804) and the first transmission (301) through the controllable clutch unit (CL5011), and/or transmits the rotary kinetic energy between the umbrella-type planetary gear power transmission rocker arm (804) and the second transmission (302) through the controllable clutch unit (CL5012); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

39. The dual gear train driving structure at input side of basin-type gear as claimed in claim 38, in which the speed variable transmission (T201) is additionally installed between the output terminal of the second driving unit (201) and the input terminal of the second transmission (302) to change the speed ratio between the output terminal of the second driving unit (201) and the input terminal of the second transmission (302).

40. The dual gear train driving structure at input side of basin-type gear as claimed in claim 38, in which two electric machineries further constitute the second driving units (201) and (202), and two or one of the electric machineries drive the input terminal of the second transmission (302).

41. The dual gear train driving structure at input side of basin-type gear as claimed in claim 39, in which two electric machineries further constitute the second driving units (201) and (202), and two or one of the electric machineries respectively through the speed variable transmission (T201) and the speed variable transmission (T202) drive the input terminal of the second transmission (302).

42. The dual gear train driving structure at input side of basin-type gear as claimed in claim 1, in which the second driving unit (201) further constituted by the single electric machinery drives the input terminal of the second transmission (302), the umbrella-type planetary gear power transmission rocker arm (804) is installed at two sides of the differential gear set (800), and the controllable clutch unit (CL5011) is installed between one side of the umbrella-type planetary gear power transmission rocker arm (804) and the basin-type bevel gear of the first transmission (504), while the controllable clutch unit (CL5012) is installed between the other side of the umbrella-type planetary gear power transmission rocker arm (804) and the second transmission (302), the main components including:
differential gear set assembly (300): equipped with the controllable clutch units (CL5011) and (CL5012), in which the umbrella-type planetary gear power transmission rocker arm (804) is installed at two sides of the differential gear set (800), and the controllable clutch unit (CL5011) is installed between one side of the umbrella-type planetary gear power transmission rocker arm (804) and the basin-type bevel gear of the first transmission (504), while the controllable clutch unit (CL5012) is installed between the other side of the umbrella-type planetary gear power transmission rocker arm (804) and the driving wheel of the second transmission (302), so as to control engaged or disengaged operation in various permutations and combinations between the controllable clutch unit (CL5011) and the controllable clutch unit (CL5012) on the basis of operational function, including that the first transmission (301) is constituted by the first transmission input bevel gear (503) and the basin-type bevel gear of the first transmission (504), and the first driving unit (101) directly or through the controllable clutch unit (CL101) and/or through the speed variable transmission drives the first transmission input bevel gear (503), then the first transmission input bevel gear (503) drives the basin-type bevel gear of the first transmission (504), and further drives the umbrella-type planetary gear power transmission rocker arm (804) through the controllable clutch unit (CL5011); and/or the rotary kinetic energy of the second driving unit (201) drives the umbrella-type planetary gear power transmission rocker arm (804) through the second transmission (302) and the controllable clutch unit (CL5012); and the differential gear set (800) is installed with the differential output shaft (311) and the differential output shaft (312) to coaxially output externally, and is equipped with the case and the bearing of differential gear set assembly;
controllable clutch units (CL5011), (CL5012): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side; and
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the umbrella-type planetary gear power transmission rocker arm (804) and the first transmission (301) through the controllable clutch unit (CL5011), and/or transmits the rotary kinetic energy between the umbrella-type planetary gear power transmission rocker arm (804) and the second transmission (302) through the controllable clutch unit (CL5012).

43. The dual gear train driving structure at input side of basin-type gear as claimed in claim 42, in which the speed variable transmission (T201) is installed between the output terminal of the second driving unit (201) and the input terminal of the second transmission (302) to change the speed ratio between the output terminal of the second driving unit (201) and the input terminal of the second transmission (302).

44. The dual gear train driving structure at input side of basin-type gear as claimed in claim 42, in which two electric machineries are further installed for constituting the second driving units (201) and (202), and two or one of the electric machineries drive the input terminal of the second transmission (302).

45. The dual gear train driving structure at input side of basin-type gear as claimed in claim 43, in which two electric machineries further constitute the second driving units (201) and (202), and two or one of the electric machineries respectively through the speed variable transmission (T201) and the speed variable transmission (T202) drive the input terminal of the second transmission (302).

46. The dual gear train driving structure at input side of basin-type gear as claimed in claim 1, in which the umbrella-type planetary gear power transmission rocker arm (804) of the differential gear set (800) further extends toward two sides, and the basin-type bevel gear of the first transmission (504) and the first transmission input bevel gear (503), and the basin-type bevel gear of the second transmission (5042) and the second transmission input bevel gear (507) are installed, the two sets are in separation, wherein the first transmission input bevel gear (503) is driven by the first driving unit (101), then is through the basin-type bevel gear of the first transmission (504) to drive one side of the umbrella-type planetary gear power transmission rocker arm (804), while the second transmission input bevel gear (507) is driven by the second driving unit (201), then is through the basin-type bevel gear of the second transmission (5042) to drive the other side of the umbrella-type planetary gear power transmission rocker arm (804), whereas the umbrella-type planetary gear power transmission rocker arm (804) transmits the rotary kinetic energy to the differential gear set (800), the main components including:
differential gear set assembly (300): the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, wherein the first transmission input bevel gear (503) is directly or through the controllable clutch unit (CL101) driven by the first driving unit (101), then is through the basin-type bevel gear of the first transmission (504) to drive one side of the umbrella-type planetary gear power transmission rocker arm (804), while the second transmission input bevel gear (507) is driven by the second driving unit (201), then is through the basin-type bevel gear of the second transmission (5042) to drive the other side of the umbrella-type planetary gear power transmission rocker arm (804);
controllable clutch unit (CL101): constituted by clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) and/or the second transmission (302) through the umbrella-type planetary gear power transmission rocker arm (804); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

47. The dual gear train driving structure at input side of basin-type gear as claimed in claim 46, including that the single electric machinery constitutes the second driving unit (201), and the speed variable transmission (T201) is installed between the second driving unit (201) and the second transmission (302) to change the speed ratio between the output terminal of the second driving unit (201) and the second transmission input bevel gear (507).

48. The dual gear train driving structure at input side of basin-type gear as claimed in claim 1, including that the single electric machinery constitutes the second driving unit (201) for driving the second transmission input bevel gear (507) at the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, the two sets are in separation, and the controllable clutch unit (CL500) is installed between the basin-type bevel gear of the second transmission (5042) and the umbrella-type planetary gear power transmission rocker arm (804), the main components including:
differential gear set assembly (300): it is arranged that the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, and the controllable clutch unit (CL500) is installed between the basin-type bevel gear of the second transmission (5042) and the umbrella-type planetary gear power transmission rocker arm (804), wherein the first transmission input bevel gear (503) is driven by the first driving unit (101), then is through the basin-type bevel gear of the first transmission (504) to drive one side of the umbrella-type planetary gear power transmission rocker arm (804), while the second transmission input bevel gear (507) is driven by the second driving unit (201), then is through the basin-type bevel gear of the second transmission (5042) to drive the controllable clutch unit (CL500), and to further drive the other side of the umbrella-type planetary gear power transmission rocker arm (804);
controllable clutch units (CL101), (CL500): constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the differential gear set (800) and the first transmission (301) through the umbrella-type planetary gear power transmission rocker arm (804), and/or transmits the rotary kinetic energy between the differential gear set (800) and the second transmission (302) through the controllable clutch unit (CL500); and
the above structures constituting the dual gear train driving structure at input side of basin-type gear, in which the differential output shaft (311) and the differential output shaft (312) of the differential gear set assembly (300) are driven by the first driving unit (101) and/or the second driving unit (201) to implement differential operation.

49. The dual gear train driving structure at input side of basin-type gear as claimed in claim 48, including that the single electric machinery constitutes the second driving unit (201), and the speed variable transmission (T201) is installed between the output terminal of the second driving unit (201) and the second transmission input bevel gear (507) at the input terminal of the second transmission (302) to change the speed ratio between the output terminal of the second driving unit (201) and the second transmission input bevel gear (507).

50. The dual gear train driving structure at input side of basin-type gear as claimed in claim 1, including that the single electric machinery constitutes the second driving unit (201) for driving the input terminal of the second transmission (302), the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, the two sets are in separation, the controllable clutch unit (CL5011) is installed between the basin-type bevel gear of the first transmission (504) and the umbrella-type planetary gear power transmission rocker arm (804), and the controllable clutch unit (CL5012) is installed between the basin-type bevel gear of the second transmission (5042) and the umbrella-type planetary gear power transmission rocker arm (804), the main components including:
differential gear set assembly (300): it is arranged that the umbrella-type planetary gear power transmission rocker arm (804) of the differential gear set (800) extends toward two sides, the basin-type bevel gear of the first transmission (504) and the first transmission input bevel gear (503), and the basin-type bevel gear of the second transmission (5042) and the second transmission input bevel gear (507) are installed, and the two sets are in separation, the controllable clutch unit (CL5011) is installed between the basin-type bevel gear of the first transmission (504) and the umbrella-type planetary gear power transmission rocker arm (804), while the controllable clutch unit (CL5012) is installed between the basin-type bevel gear of the second transmission (5042) and the umbrella-type planetary gear power transmission rocker arm (804), wherein the first transmission input bevel gear (503) is driven by the first driving unit (101), then is through the basin-type bevel gear of the first transmission (504) to drive the controllable clutch unit (CL5011), and further drives one side of the umbrella-type planetary gear power transmission rocker arm (804), whereas, the second transmission input bevel gear (507) is driven by the second driving unit (201), then is through the basin-type bevel gear of the second transmission (5042) to drive the controllable clutch unit (CL5012), and to further drive the other side of the umbrella-type planetary gear power transmission rocker arm (804);
controllable clutch units (CL5011), (CL5012): constituted by the clutch unit or structure capable of performing the function of transmission engagement or disengagement, which is driven by human power, and/or electric power, and/or magnetic force, and/or machine power, and/or atmospheric pressure, and/or hydraulic pressure, and/or centrifugal force, and is equipped with the rotary input side and the rotary output side;
differential gear set (800): related to the umbrella-type differential gear constituted by the umbrella-type gear or the umbrella-type friction wheel, in which the left umbrella-type differential output wheel (801) and the right umbrella-type differential output wheel (802) together couple to the umbrella-type planetary gear set (803), and the umbrella-type planetary gear set (803) is installed to the umbrella-type planetary gear power transmission rocker arm (804), and transmits the rotary kinetic energy between the umbrella-type planetary gear power transmission rocker arm (804) and the first transmission (301) through the controllable clutch unit (CL5011), and/or transmits the rotary kinetic energy between the umbrella-type planetary gear power transmission rocker arm (804) and the second transmission (302) through the controllable clutch unit (CL5012).

51. The dual gear train driving structure at input side of basin-type gear as claimed in claim 50, including that the single electric machinery constitutes the second driving unit (201), and the speed variable transmission (T201) is installed between the output terminal of the second driving unit (201) and the second transmission input bevel gear (507) at the input terminal of the second transmission (302) to change the speed ratio between the output terminal of the second driving unit (201) and the second transmission input bevel gear (507).
